(19) United States
(12) Patent Application Publication
(10) Pub. No.: US 2026/0184544 A1
(43) Pub. Date: Jul. 2, 2026

(54) AUTONOMOUS TRANSPORT VEHICLE

(71) Applicant: Symbotic LLC, Wilmington, MA (US)

(72) Inventor: Nate Watts, Wilmington, MA (US)

(21) Appl. No.: 18/953,899

(22) PCT Filed: May 19, 2023
(86) PCT No.: PCT/US2023/067232

§ 371 Date: Nov. 20, 2024

Related U.S. Application Data
(60) Provisional application No. 63/365,089, filed on May 20, 2022.

(51) Int. Cl. B66F 9/06; B65G 1/137; B66F 9/14

(52) U.S. Cl. CPC B66F 9/063; B65G 1/137; B66F 9/14

(57) ABSTRACT

An autonomous transport vehicle for a storage and retrieval system, the autonomous s transport vehicle comprising, a longitudinally elongated frame having a payload area, the payload area having opposing lateral sides, and wheels supporting the longitudinally elongated frame so as to configure the frame for traverse along traverse surfaces of a transfer deck and picking aisles of a storage and retrieval system, where the transfer deck provides vehicle traverse access to each of the picking aisles, and a transfer arm coupled to the frame and disposed, at least in part, within the payload area, the transfer arm including telescoping fingers configured to support a payload and bi-directionally extend, from the payload area, from one of both of the opposing lateral sides to effect picking and placing of the payload at a payload holding location, of the picking aisle, adjacent the one of both of the opposing lateral sides.

### CROSS-REFERENCE TO RELATED APPLICATIONS

This application is the National Stage of International Application number PCT/US2023/067232, having an International Filing Date of May 19, 2023, which designated the United States of America, and with International Application was published under PCT Article 21(2) as WO Publication No. 2023/225642 A1, and which claims priority from, and the benefit of, U.S. provisional Application No. 63/365,089 filed on May 20, 2022, the disclosures of which are incorporated herein by reference in their entireties.

### BACKGROUND

### 1. Field

The present disclosure generally relates to material handling systems, such as automated storage and retrieval systems, and more particularly, to automated case transport.

### 2. Brief Description of Related Developments

Generally the storage of items within, for example, a warehouse requires a large building or storage structure space with an associated footprint. Automated vehicles or robots may be used in these warehouses to place items in storage and remove items from storage.

It would be advantageous to have an automated vehicle that can efficiently pick items for placement in and transfer from the storage structure while reducing congestion of automated vehicle traverse within the storage structure.

### BRIEF DESCRIPTION OF THE DRAWINGS

The foregoing aspects and other features of the present disclosure are explained in the following description, taken in connection with the accompanying drawings, wherein:

FIG. 1 is a schematic illustration of a material handling system in accordance with aspects of the present disclosure;

FIG. 2 is a schematic illustration of a portion of the material handling system of FIG. 1 in accordance with aspects of the present disclosure;

FIG. 3 is a schematic illustration of an exemplary automated transport vehicle of the material handling system of FIG. 1 in accordance with aspects of the present disclosure;

FIG. 4 is a schematic illustration of a portion of the automated transport vehicle of FIG. 3 in accordance with aspects of the present disclosure;

FIG. 5 is a schematic illustration of a portion of the automated transport vehicle of FIG. 3 in accordance with aspects of the present disclosure;

FIG. 6 is a schematic illustration of a portion of the material handling system in accordance with aspects of the present disclosure;

FIG. 7A is a schematic illustration of a portion of the automated transport vehicle of FIG. 3 in accordance with aspects of the present disclosure;

FIGS. 7B, 7C, 7D, 7E, 7F, 7G, and 7H are schematic illustrations of portions of the automated transport vehicle of FIG. 3 in accordance with aspects of the present disclosure;

FIG. 8 is a schematic illustration of a portion of the automated transport vehicle of FIG. 3 in accordance with aspects of the present disclosure;

FIGS. 9A and 9B are schematic illustrations of portions of the material handling system of FIG. 1 in accordance with aspects of the present disclosure;

FIGS. 10A, 10B, 10C, 10D, and 10E are schematic illustrations of a portion of the automated transport vehicle of FIG. 3 in accordance with aspects of the present disclosure;

FIG. 11 is an exemplary flow diagram of a method in accordance with aspects of the present disclosure;

FIG. 12 is an exemplary flow diagram of a method in accordance with aspects of the present disclosure; and

FIG. 13 is an exemplary flow diagram of a method in accordance with aspects of the present disclosure.

### DETAILED DESCRIPTION

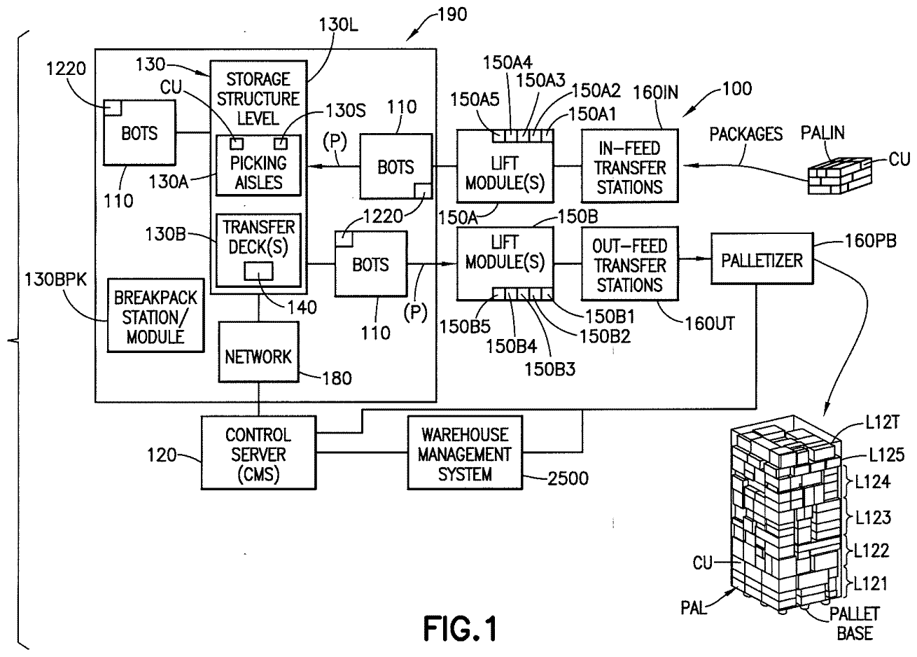

FIG. 1 illustrates an exemplary automated storage and retrieval system (also referred to herein as a material handling system) 100 for handling and placing packages onto pallets destined for an order store (e.g., retail store, business customer, or another warehouse) in accordance with aspects of the present disclosure. Although the aspects of the present disclosure will be described with reference to the drawings, it should be understood that the aspects of the present disclosure could be embodied in many forms. In addition, any suitable size, shape, or type of elements or materials could be used.

In accordance with the aspects of the present disclosure, the automated storage and retrieval system 100 in FIG. 1 may be disposed in a retail distribution center or warehouse, for example, to fulfill orders received from retail stores for replenishment goods shipped in cases, packages, and/or parcels. The terms case, package, and parcel are used interchangeably herein and may be any container that may be used for shipping and may be filled with case or more product units by the producer. Case or cases as used herein means case, package or parcel units not stored in trays, on totes, etc. (e.g. uncontained). It is noted that the case units CU (also referred to herein as mixed cases, cases, packages, boxes, and shipping units or generally as payloads) may include cases of items/unit (e.g. case of soup cans, boxes of cereal, etc.) or individual item/units that are adapted to be taken off of or placed on a pallet. In accordance with the exemplary embodiments, shipping cases or case units (e.g. cartons, barrels, boxes, crates, jugs, shrink wrapped trays or groups or any other suitable device for holding case units) may have variable sizes and may be used to hold case units in shipping and may be configured so they are capable of being palletized for shipping. It is noted that when, for example, incoming bundles or pallets (e.g. from manufacturers or suppliers of case units arrive at the storage and retrieval system for replenishment of the automated storage and retrieval system 100, the content of each pallet may be uniform (e.g. each pallet holds a predetermined number of the same item-one pallet holds soup and another pallet holds cereal). As may be realized, the cases of such pallet load may be substantially similar or in other words, homogenous cases (e.g. similar dimensions), and may have the same SKU (otherwise, as noted before the pallets may be “rainbow” pallets having layers formed of homogeneous cases). As pallets leave the storage and retrieval system, with cases filling replenishment orders, the pallets may contain any suitable number and combination of different case units (e.g. each pallet may hold different types of case units-a pallet holds a combination of canned soup, cereal, beverage packs, cosmetics and household cleaners). The cases combined onto a single pallet may have different dimensions and/or different SKU's.

A schematic perspective view of an exemplary mixed case pallet load PAL output from the storage and retrieval system 100 is illustrated in FIG. 1. It is noted that when, for example, incoming bundles or pallets PALIN (e.g. from manufacturers or suppliers of case units arrive at the storage and retrieval system for replenishment of the automated storage and retrieval system 100, the content of each pallet may be uniform (e.g. each pallet holds a predetermined number of the same item-one pallet holds soup and another pallet holds cereal). As may be realized, the cases of such pallet load PALIN may be substantially similar or in other words, homogenous cases (e.g. similar dimensions), and may have the same SKU (otherwise, as noted before the pallets may be “rainbow” pallets having layers formed of homogeneous cases). The pallet load PAL output from the storage and retrieval system, and shown in FIG. 1, may be referred to as a level layer pallet, wherein the pallet is built by placing cases one case layer L121-L125, L12T at a time (cases may be placed individually or in partial or whole layers as noted above until the level layer L121-L125, L12T is complete before proceeding to the next level layer L121-L125, L12T. In one aspect, the pallet load PAL (or a portion thereof) may be loaded with cases in columns or stacked in layers to a maximum allowable pallet height, such as for example, 48 inches (including a height of the pallet base) for a standard short pallet or 96 inches (including the height of the pallet base) for a standard tall pallet (in other aspects, the pallets may be taller or shorter so as to have a non-standard height). Cases within layers rest on support surfaces of the underlying (e.g., inferior) case layers within the pallet load PAL, and conversely the underlying case layer surfaces delimit the cases in layers (e.g., superior/superposed layers) that may be placed above. The pallet loads PAL are highly heterogeneous and may be formed with a pallet planner arrangement (similar to that described in U.S. Pat. No. 8,965,559 issued on Feb. 24, 2015 and titled “Pallet Building System”, and/or U.S. Pat. No. 11,305,430 issued on Apr. 19, 2022, the disclosures of which are incorporated herein by reference in their entireties.

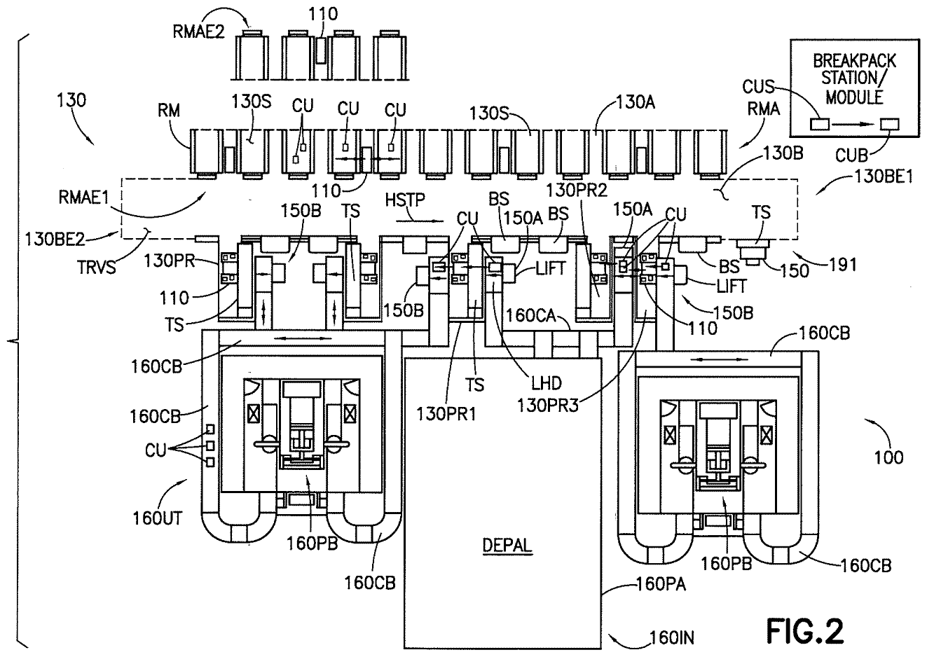

In accordance with aspects of the present disclosure, and referring to FIGS. 1 and 2, the system 100 may be generally configured to include an in-feed section, a storage and sortation section (e.g., multilevel transport system 190), and an output section. The system 100 operating for example as a retail distribution center may serve to receive uniform pallet loads PALIN of cases, breakdown the pallet goods or disassociate the cases from the uniform pallet loads PALIN into independent case units CU handled individually by the system 100, retrieve and sort the different cases sought by each order into corresponding groups, and transport and assemble the corresponding groups of cases into what may be referred to as mixed case pallet loads PAL. The in-feed section may generally be capable of resolving the uniform pallet loads PALIN to individual cases, and transporting the cases via suitable transport, for input to the storage and sortation section. The storage and sortation section in turn may receive individual cases, store them in a storage area and retrieve desired cases individually in accordance with commands generated in accordance with orders entered into a warehouse management system 2500 for transport to the output section. The sorting and grouping of cases according to order may be performed in whole or in part by either the storage and retrieval section or the output section, or both, the boundary between being one of convenience for the description and the sorting and grouping being capable of being performed any number of ways as will be described further below. The intended result is that the output section assembles the appropriate group of ordered cases, that may be different in stock keeping unit (SKU), dimensions, etc. into mixed case pallet loads PAL.

In greater detail now, and with reference still to FIGS. 1 and 2, the storage and retrieval system 100 may be configured for installation in, for example, existing warehouse structures or adapted to new warehouse structures. As noted before the system 100 shown in FIGS. 1 and 2 is representative and may include for example, input stations 160IN (which include depalletizers 160PA and/or conveyors 160CA for transporting items to lift modules 150A for entry into storage) and output stations 160UT (which include palletizers 160PB, operator stations 160EP and/or conveyors 160CB for transporting case units from lift modules 150B for removal from storage), input and output vertical lift modules 150A, 150B (generally referred to as lift modules 150—it is noted that while input and output lift modules are shown, a single lift module may be used to both input and remove case units from the storage structure), a storage structure 130, and a number of autonomous rovers/vehicles or transport vehicles 110 (referred to herein as “bots”). It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets (FIG. 1) for shipping.

At least the storage structure 130 (including one or more of the picking aisles 130A, storage spaces 130S (also referred to herein as storage locations) and transfer deck 130B of each different storage structure level 130L) and bots 110 may be collectively referred to herein as the multi-level transport system 190 (also referred to herein as an automated package transport system) that is communicably connected to the storage array (e.g., formed by the storage rack module array RMA) for storing case units CU within storage spaces 130S of the storage array and retrieving case unis CU from the storage spaces 130S of the storage array. Each level 130L of the multi-level transport system 190 having a corresponding asynchronous level transport system 191 (see FIG. 2, which includes, e.g., the bots 110, the picking aisles 130A, storage spaces 130S and transfer deck 130B of the respective level 130L), of mixed cases, that is separate and distinct from the level transport system 191 corresponding to each other level 130L of the multi-level transport system 190.

The lift modules 150 may be shown as reciprocating lifts in the figures; however, in other aspects the lift modules 150 may be any suitable vertically configured item handling device(s) such as, for example, an elevator (e.g., reciprocating lift) 150A1, 150B1, escalator 150A2, 150B2, angled conveyor belt 150A3, 150B3, unmanned aerial vehicle (e.g., a drone, quadcopter, multi-copter, etc.) 150A4, 150B4, and/or crane/hoist 150A5, 150B5. In some aspects, the lift modules 150A, 150B may form vertical sequencers in addition to the storage and retrieval engine 190 as described in U.S. patent application Ser. No. 16/444,592 filed on Jun. 18, 2019, the disclosure of which is incorporated herein by reference in its entirety).

The storage structure 130 may include multiple levels (e.g., storage levels 130L) of storage rack modules RMA (e.g., forming a storage array with storage space(s) 130S for holding case units CU therein) where each level 130L includes respective picking aisles 130A, and transfer decks 130B for transferring case units CU between any of the storage areas 130S of the storage structure 130 and a shelf of the lift module(s) 150A, 150B. The picking aisles 130A, and transfer decks 130B also allow the bots 110 to place case units CU into picking stock and to retrieve ordered case units CU. In alternate aspects, each storage level 130L may also include respective bot transfer stations TS for indirectly transferring case units between the bots 110 and the lifts 150A, 150B; while in other aspects the transfer of case units CU between the bots 110 and the lifts 150A, 150B may be a direct transfer.

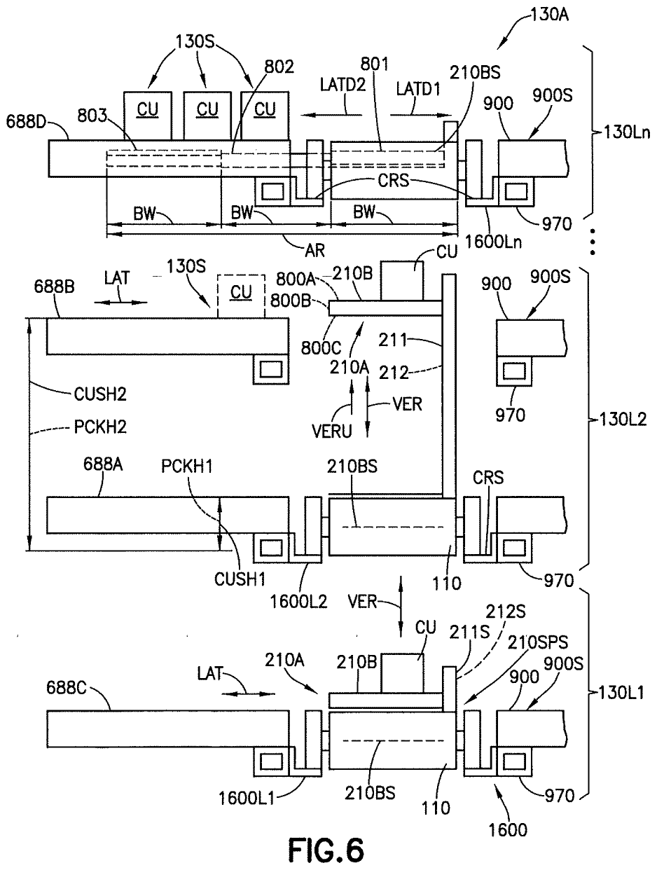

The bots 110, described in greater detail herein, may be configured to place case units, such as the above described retail merchandise, into picking stock in the one or more levels 130L of the storage structure 130 and then selectively retrieve ordered case units for shipping the ordered case units to, for example, a store or other suitable location. For example, each storage level 130L includes pickface storage/handoff spaces 130S (referred to herein as storage spaces/locations 130S) formed by the rack modules RM. The storage spaces 130S formed by the rack modules RM, in one aspect, include shelves that are disposed along storage or picking aisles 130A (that are connected to the transfer deck 130B) which, e.g., extend linearly through the rack module array RMA and provide bot 110 access to the storage spaces 130S and transfer deck(s) 130B. In other aspects, the storage spaces 130S formed by the rack modules RM may include slots, receptacles, stalls, cribs, cordoned areas, hooks, racks, or other suitable locations with a configuration that allows the bots 110 to pick and place case units CU to and from the storage spaces 130S. In one aspect, the shelves of the rack modules RM are arranged as multi-level shelves that are distributed along the picking aisles 130A (see also FIG. 6). As may be realized the bots 110 travel on a respective storage level 130L along the picking aisles 130A and the transfer deck 130B for transferring case units between any of the storage spaces 130S of the storage structure 130 (e.g. on the level which the bot 110 is located) and any of the lift modules 150 (e.g. each of the bots 110 has access to each storage space 130S on a respective level and each lift module 150 on a respective storage level 130L). The transfer decks 130B are arranged at different levels (corresponding to each level 130L of the storage and retrieval system) that may be stacked one over the other or horizontally offset, such as having one transfer deck 130B at one end or side RMAE1 of the storage rack array RMA or at several ends or sides RMAE1, RMAE2 of the storage rack array RMA as described in, for example, U.S. patent application Ser. No. 13/326,674 filed on Dec. 15, 2011 the disclosure of which is incorporated herein by reference in its entirety. In other aspects, the storage structure may not have transfer decks on one or more of the level 130L, where the picking aisles may extend so that the bots 110 have access to one or more lifts disposed on a side of the picking aisle in a manner similar to that described in, for example, U.S. Pat. No. 8,974,168 issued on Mar. 10, 2015, the disclosure of which is incorporated herein by reference in its entirety.

The system 100 may also include one or more breakpack stations or modules 130BPK configured to remove individual items (e.g., breakpack goods or vendor packs) from supply containers CUS (e.g., stored in the rack modules RM and transported to the breakpack stations 130BPK by the bots 110) and group them together in a breakpack container CUB, where a customer order includes at least one or more breakpack containers CUB. Suitable examples of breakpack stations are described in U.S. patent application Ser. No. 17/358,383, filed on Feb. 14, 2022 and U.S. patent application Ser. No. 17/657,705 filed on Apr. 1, 2022 both titled “Warehouse System for Storing and Retrieving Goods in Containers,” the disclosures of which are incorporated herein by reference in their entireties.

The in-feed transfer stations 170 and out-feed transfer stations 160 may operate together with their respective lift module(s) 150A, 150B for bi-directionally transferring case units CU to and from one or more levels 130L of the storage structure 130. It is noted that while the lift modules 150A, 150B may be described as being dedicated inbound lift modules 150A and outbound lift modules 150B, in alternate aspects each of the lift modules 150A, 150B may be used for both inbound and outbound transfer of case units/case units from the storage and retrieval system 100.

As may be realized, the storage and retrieval system 100 may include multiple in-feed and out-feed lift modules 150A, 150B that are accessible by, for example, bots 110 of the storage and retrieval system 100 so that one or more case unit(s), uncontained (e.g. case unit(s) are not held in trays), or contained (within a tray or tote) can be transferred from a lift module 150A, 150B to each storage space on a respective level 130L and from each storage space to any one of the lift modules 150A, 150B on a respective level 130L. The lift modules 150A, 150B are accessible from the transfer deck 130B in any suitable manner. For example, the lifts 150 may be arranged along the travel deck (e.g., adjacent an edge of the travel deck) where a bot 110 accesses the lift 150 (or a respective lift transfer station TS) directly from the transfer deck) as illustrated in FIG. 2; or the bots 110 access the lifts 150 with or by an extension portion or pier 130PR that extends from the transfer deck 130B. The pier 130PR includes a transfer station TS at which the bot 110 is positioned for transferring case units to and from a respective lift module(s) 150A, 150B. In one aspect, the pier 130PR is similar to the picking aisles 130A where the bot 110 travels along rails 1600 (see FIG. 6) affixed to horizontal support members 970 of the storage structure (see FIG. 6). In other aspects, the travel surface of the pier 130PR may be substantially similar to that of the transfer deck 130B. Each pier 130PR is located at the side of the transfer deck 130B, such as a side that is opposite the picking aisles 130A and rack modules RM, so that the transfer deck 130B is interposed between the picking aisles and each pier 130PR. The pier(s) 130PR extends from the transfer deck at a non-zero angle relative to at least a portion of a high speed bot transport path HSTP. In other aspects the pier(s) 130PR extend from any suitable portion of the transfer deck 130B including the ends 130BE1, 130BE2 of the transfer deck 130B. As may be realized, peripheral buffer stations (substantially similar to peripheral buffers stations BS described above) may also be located at least along a portion of the pier 130PR. As can be seen in FIG. 2, lifts 150 (outbound lift modules 150B and inbound lift modules 150A) are disposed adjacent respective piers 130PR where the lifts 150 are disposed adjacent the transfer stations TS. In FIG. 2, one or more lifts may be positioned adjacent each pier 130PR (e.g., on a same side of a respective pier and/or on opposite sides of a respective pier).

The bots 110 may be configured to transfer the case units CU between the storage spaces and the lift modules 150A, 150B. Generally, the lift modules 150A, 150B include at least one movable payload support that may move the case unit(s) between the in-feed and out-feed transfer stations 160, 170 and the respective level of the storage space where the case unit(s) is stored and retrieved. The lift module(s) may have any suitable configuration, such as for example a reciprocating lift, or any other suitable configuration. The lift module(s) 150A, 150B include any suitable controller (such as controller 120 or other suitable controller coupled to controller 120, warehouse management system 2500, and/or palletizer controller 164) and may form a sequencer or sorter in a manner similar to that described in U.S. patent application Ser. No. 16/444,592 filed on Jun. 18, 2019 (the disclosure of which is incorporated herein by reference in its entirety) that sequences the mixed cases CU according to the predetermined mixed case sequence solution, the predetermined mixed case sequence solution being generated as described herein for the palletizer 160PB to build the pallet load PAL.

The automated storage and retrieval system may include a control system, comprising for example one or more control servers 120 that are communicably connected to the in-feed and out-feed conveyors and transfer stations 170, 160, the lift modules 150A, 150B, and the bots 110 via a suitable communication and control network 180. The communication and control network 180 may have any suitable architecture, which for example, may incorporate various programmable logic controllers (PLC) such as for commanding the operations of the in-feed and out-feed conveyors and transfer stations 170, 160, the lift modules 150A, 150B, and other suitable system automation. The control server 120 may include high-level programming that effects a case management system (CMS) 120 managing the case flow system. The network 180 may further include suitable communication for effecting a bi-directional interface with the bots 110. For example, the bots 110 may include an on-board processor/controller 1220. The network 180 may include a suitable bi-directional communication suite enabling the bot controller 1220 to request or receive commands from the control server 180 for effecting desired transport (e.g. placing into storage locations or retrieving from storage locations) of case units and to send desired bot 110 information and data including bot 110 ephemeris, status and other desired data, to the control server 120. As seen in FIG. 2, the control server 120 may be further connected to a warehouse management system 2500 for providing, for example, inventory management, and customer order fulfillment information to the CMS 120 level program. A suitable example of an automated storage and retrieval system arranged for holding and storing case units is described in U.S. Pat. No. 9,096,375, issued on Aug. 4, 2015 the disclosure of which is incorporated by reference herein in its entirety.

Referring still to FIGS. 1 and 2, in the aspects of the present disclosure the out-feed section of system 100, and more specifically out-feed transfer station and conveyors 160 extending therefrom serve to transport case units retrieved from storage to palletizer 160PB. A suitable example of a palletizer 160PB is described in U.S. patent application Ser. No. 16/035,204 filed on Jul. 13, 2018 and titled “Apparatus and Method for Building a Pallet Load”, the disclosure of which is incorporated herein by reference in its entirety. The interface (not shown) between the out-feed section conveyors and palletizer 160PB may have any desired configuration that facilitates substantially unimposed (with respect to output of the system out-feed section) arrival of ordered case units and placement for unconstrained picking of the case units by the palletizer for building the mixed case pallet load PAL.

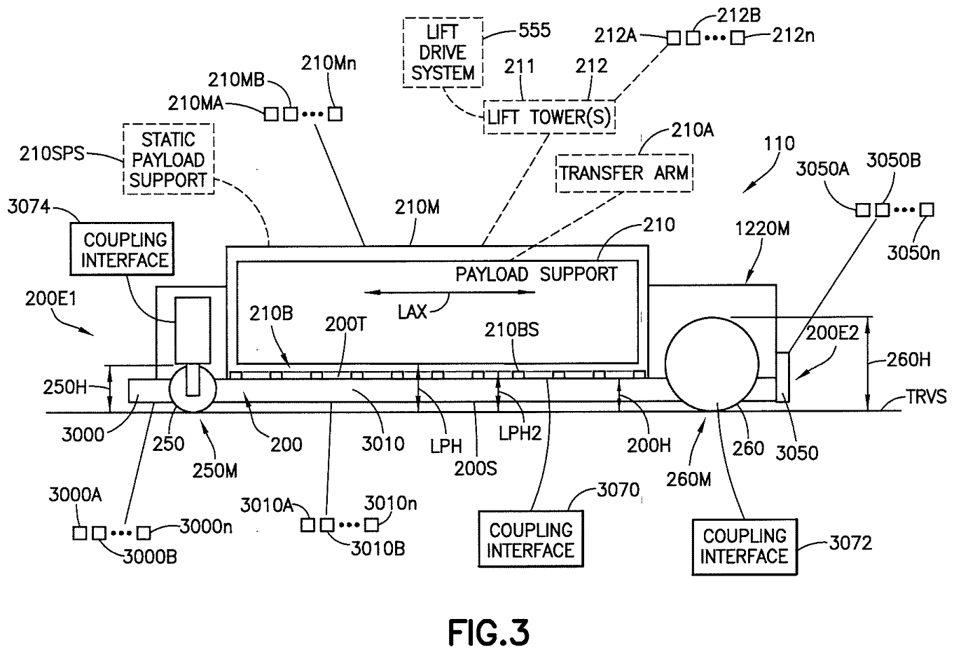

Referring now to FIGS. 3, 4, and 5, the autonomous transport vehicle or bot 110 may be any suitable independently operable autonomous transport vehicle that carries and transfers/transports case units and/or pickfaces (inclusive of breakpack goods containers) throughout the storage and retrieval system 100. In one aspect the bots 110 are automated, independent (e.g. free riding) autonomous transport vehicles. Suitable examples of bots can be found in, for exemplary purposes only, U.S. Pat. No. 10,822,168 issued on Nov. 3, 2020; U.S. Pat. No. 8,425,173 issued on Apr. 23, 2013); U.S. Pat. No. 9,561,905 issued on Feb. 7, 2017; U.S. Pat. No. 8,965,619 issued Feb. 24, 2015; U.S. Pat. No. 8,696,010 issued on Apr. 15, 2014; U.S. Pat. No. 9,187,244 issued Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; U.S. Pat. No. 9,850,079 issued on Dec. 26, 2017; and U.S. patent application Ser. No. 17/664,843, filed on May 24, 2022 having attorney docket number 1127P016040-US (PAR) and tiled “Autonomous Transport Vehicle, and which is a non-provisional of U.S. provisional patent application No. 63/241,893 filed on Sep. 8, 2021, the disclosures of which are incorporated by reference herein in their entireties.

For exemplary purposes, the bot 110 includes a chassis or chassis bus 200 having a front end 200E1 and a back end 200E2 that define a longitudinal axis LAX of the autonomous transport vehicle 110. The chassis 200 is a space frame 200S and may be constructed (e.g., formed) of any suitable material including but not limited to steel, aluminum, and composites. The space frame 200S has predetermined modular coupling interfaces that have known locations relative to each other and include datums for repeatedly positioning/locating components of the autonomous transport vehicle on the frame and relative to each other in a repeatable manner as described in, for example, U.S. patent application Ser. No. 17/664,843, filed on May 24, 2022 having attorney docket number 1127P016040-US (PAR) and tiled “Autonomous Transport Vehicle, and which is a non-provisional of U.S. provisional patent application No. 63/241,893 filed on Sep. 8, 2021, the disclosures of which were previously incorporated herein by reference in their entireties. Each of the modular coupling interfaces is disposed for removably coupling, as a modular unit, a corresponding predetermined electronic and/or mechanical component module of the autonomous transport vehicle 110 to the chassis 200 so that the autonomous transport robot vehicle 110 has a modular construction. The predetermined electronic and/or mechanical component modules include, but are not limited to ride wheel modules (e.g., at least one drive wheel module 260M and at least one caster wheel module 250M), payload support module 210M, control module 1220M, etc. The drive wheel module 260M has a drive wheel 260 removably coupled as a module unit to the chassis 200 in any suitable repeatable manner so that one drive wheel module may be replaced with another different drive wheel module at substantially the same location on the chassis 200. The caster wheel module 250M has a caster wheel 250 removably coupled as a module unit to the chassis 200 in any suitable manner so that one caster wheel module may be replaced with another different caster wheel module at substantially the same location on the chassis 200. The payload support module 210M has a payload bed 210B with a payload support contact surface 210BS removably coupled as a module unit to the chassis 200 in any suitable manner so that one payload support module may be replaced with another different payload support module at substantially the same location on the chassis 200.

The autonomous transport vehicle 110 also includes a case handling assembly or payload support 210 configured to handle cases/payloads transported by the autonomous transport vehicle 110. The payload support 210 may be provided as the payload support module 210M and is removably connected to the chassis 200 (e.g., with mechanical fasteners) and is dependent therefrom. The payload support 210 includes at least any suitable payload support contact surface 210BS on which payloads are placed for transport. In one or more aspects, the payload support 210 also includes any suitable transfer arm 210A configured to transfer payloads between the autonomous transport vehicle 110 and a payload holding location (such as any suitable payload storage location, a shelf of lift module 150A, 150B, and/or any other suitable payload holding location) (see also FIG. 6).

As will be described in greater detail herein, the transfer arm 210A may be configured to bi-directionally extend laterally in direction LAT (e.g., from both lateral sides LAT1, LAT2 of the vehicle 110) and/or vertically in direction VER to transport payloads to and from a payload area of the payload support 210. Examples of suitable payload support contact surfaces 210BS and transfer arms 210A and/or autonomous transport vehicles or bots to which the aspects of the disclosed embodiment may be applied can be found in United States pre-grant publication number 2012/0189416 published on Jul. 26, 2012 (U.S. patent application Ser. No. 13/326,952 filed on Dec. 15, 2011) and titled “Automated Bot with Transfer Arm”; U.S. Pat. No. 7,591,630 issued on Sep. 22, 2009 titled “Materials-Handling System Using Autonomous Transfer and Transport Vehicles”; U.S. Pat. No. 7,991,505 issued on Aug. 2, 2011 titled “Materials-Handling System Using Autonomous Transfer and Transport Vehicles”; U.S. Pat. No. 9,561,905 issued on Feb. 7, 2017 titled “Autonomous Transport Vehicle”; U.S. Pat. No. 9,082,112 issued on Jul. 14, 2015 titled “Autonomous Transport Vehicle Charging System”; U.S. Pat. No. 9,850,079 issued on Dec. 26, 2017 titled “Storage and Retrieval System Transport Vehicle”; U.S. Pat. No. 9,187,244 issued on Nov. 17, 2015 titled “Bot Payload Alignment and Sensing”; U.S. Pat. No. 9,499,338 issued on Nov. 22, 2016 titled “Automated Bot Transfer Arm Drive System”; U.S. Pat. No. 8,965,619 issued on Feb. 24, 2015 titled “Bot Having High Speed Stability”; U.S. Pat. No. 9,008,884 issued on Apr. 14, 2015 titled “Bot Position Sensing”; U.S. Pat. No. 8,425,173 issued on Apr. 23, 2013 titled “Autonomous Transports for Storage and Retrieval Systems”; U.S. Pat. No. 8,696,010 issued on Apr. 15, 2014 titled “Suspension System for Autonomous Transports”; and U.S. patent application Ser. No. 17/664,944 filed on May 25, 2022 (having attorney docket number 1127P016039-US (PAR) and titled “Autonomous Transport Vehicle”) which is a non-provisional of U.S. provisional patent application No. 63/236,591 filed on Aug. 24, 2021, the disclosures of which are incorporated herein by reference in their entireties.

As will be described in greater detail herein, the chassis 200 includes ride wheels dependent from the chassis 200, proximate opposite end corners 200E1C1, 200E1C2, 200E2C1, 200E2C2 of the chassis 200, on which the autonomous transport vehicle 110 rides so as to traverse a traverse surface TS of the storage and retrieval system 100 storage structure level 130 on which the autonomous transport vehicle 110 is disposed. The ride wheels 250, 260 include at least one idler or caster wheel 250A, 250B and at least one drive wheel 260A, 260B supporting the chassis 200 from the traverse surface TRVS. For example, one or more idler wheels 250A, 250B are disposed adjacent the front end 200E1 (e.g., a pair of caster wheels 250A, 250B are illustrated in the figures for exemplary purposes) and one or more drive wheels 260A, 260B (e.g., a pair of drive wheels 260A, 260B are illustrated in the figures for exemplary purposes) are disposed adjacent the back end 200E2. In other aspects, the position of the idler wheels 250 and drive wheels 260 may be reversed (e.g., the drive wheels 260 are disposed at the front end 200E1 and the idler wheels 250 are disposed at the back end 200E2). It is noted that in some aspects, the autonomous transport vehicle 110 is configured to travel with the front end 200E1 leading the direction of travel or with the back end 200E2 leading the direction of travel. In one aspect, idler wheels 250A, 250B (which are substantially similar to idler wheel 250 described herein) are located at respective front corners of the chassis 200 at the front end 200E1 and drive wheels 260A, 260B (which are substantially similar to drive wheel 260 described herein) are located at respective back corners of the chassis 200 at the back end 200E2 (e.g., a support wheel is located at each of the four corners 200E1C1, 200E1C2, 200E2C1, 200E2C2 of the chassis 200) so that the autonomous transport vehicle 110 stably traverses the transfer deck(s) 130B and picking aisles 130A of the storage structure 130.

The ride wheels 250, 260 and chassis 200 in combination form a low profile height LPH (FIG. 3) that is a minimum height from the traverse surface TRVS (of the transfer deck 130B, picking aisle 130A, or any other surface on which the bot 110 traverses) to atop 200T the chassis 200, where chassis height 200H and ride wheel height (e.g., one or more of ride wheels heights 250H, 260H) are overlapped (coextensive) at least in part and a payload support contact surface 210BS of the payload support 210B (on which contact surface 210BS a payload, e.g., such as case unit CU, resting on the payload support 210B is seated) is nested within (e.g., between and within the height of at least one of) the ride wheels 250, 260 (see FIG. 3). Here, the payload support contact surface 210BS disposed atop the chassis 200. The payload support contact surface 210BS may be disposed at a height LPH2 from the traverse surface TRVS that is substantially the same as the low profile height LPH, while in other aspects the height LPH2 may be greater than the low profile height LPH while still being nested within the ride wheels 250, 260 (see FIG. 3).

Referring to FIGS. 3, 4, and 5A, the chassis 200, as noted herein, is a space frame 200S having a modular configuration/construction such that selection of chassis components from a number of different selectable chassis components configures and/or reconfigures the autonomous transport vehicle 110 (as described in U.S. patent application Ser. No. 17/664,843, filed on May 24, 2022 having attorney docket number 1127P016040-US (PAR) and tiled “Autonomous Transport Vehicle, and which is a non-provisional of U.S. provisional patent application No. 63/241,893 filed on Sep. 8, 2021, the disclosures of which are incorporated by reference herein in their entireties) for one or more of case transfer operations, employment in different storage and retrieval systems having different physical requirements for the autonomous transport vehicles 100, and/or different operational requirements of the autonomous transport vehicles 100 (e.g., suspension travel, case lift heights, clearance, ground automated charging configurations, etc.). The modular configuration of the chassis 200 also facilitates modular repair and/or maintenance of the autonomous transport vehicle 110 so as to reduce downtime (i.e., increase in-service time) of the autonomous transport vehicle 110.

The space frame 200S is configured so that the chassis 200 is substantially rigid with predetermined rigidity characteristics, with a shape and form that provide the minimum low profile height LPH from the traverse surface TS to atop 200T the chassis 200. Examples of predetermined rigidity characteristics include, but are not limited to, generating a predetermined transient response of the chassis/payload support contact surface 210BS from one or more of bot traverse transient loads (as described in U.S. patent application Ser. No. 17/664,948 filed on May 25, 2022 having attorney docket number 1127P016038-US (PAR) and titled “Autonomous Transport Vehicle with Synergistic Vehicle Dynamic Response,” which is a non-provisional of U.S. provisional patent application No. 63/213,589 filed on Jun. 22, 2021 (having attorney docket number 1127P015753-US (—#2)), the disclosure of which is incorporated herein by reference in its entirety), static and dynamic loads generated by actuation of the arm/end and transfer effector 210A, loading/unloading payloads to/from the payload bed 210B and payload transfers. The space frame 200S configuration resolves both predetermined rigidity characteristics (as to imparted loads) and the minimum low profile height LPH of the chassis 200 from the traverse surface TRVS to atop 200T the chassis 200.

As described herein, the chassis 200 has a selectably variable configuration, selectable from different configurations each having different chassis form f factors (e.g., selectably variable lengths and/or widths). The predetermined rigidity characteristics include torsional rigidity of the space frame 200S along the longitudinal axis (e.g., twisting of the chassis about the longitudinal axis), bending rigidity of the space frame 200S along the lateral direction (e.g., from side to side), and bending rigidity of the space frame 200S along the longitudinal direction (e.g., from front to back). The predetermined rigidity characteristics result in deflection, with respect to the payload carried by vehicle 110, that is negligible/indiscernible for a given payload weight (e.g., such as payloads of up to about 60 lbs or more). The deflection is negligible/indiscernible with respect to the seating of the payload across a contact surface between the payload bed 210B (or transfer arm 210A) of the vehicle 110 and the payload such that the payload remains in substantially contact with the contact surface 210BS throughout travel of and/or a range of motion of the vehicle 110.

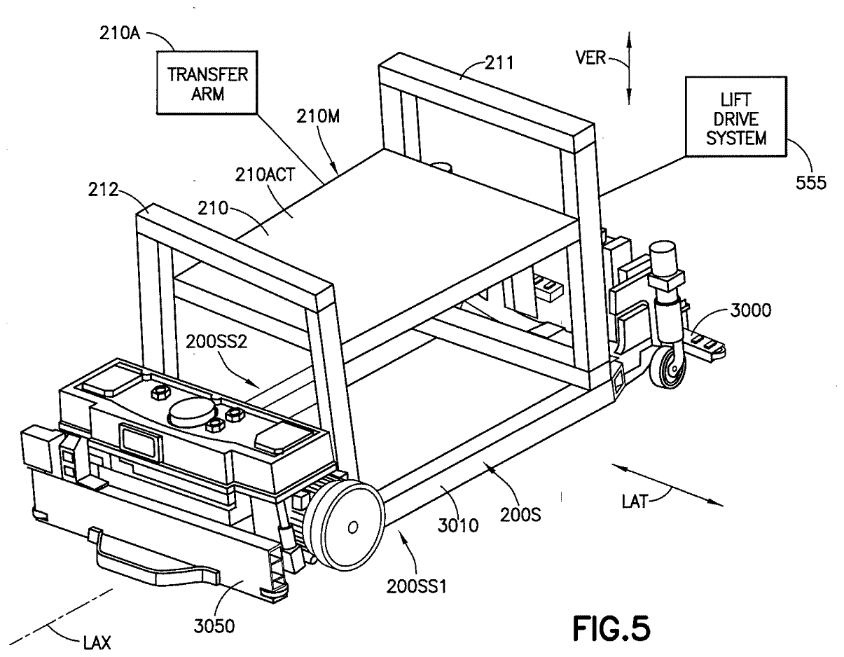

The chassis 200 includes longitudinal hollow section beams 3010 that are arrayed to form longitudinally extended sides (or lateral sides) 200SS1, 200SS2 of the space frame 200S (see FIG. 5). The chassis 200 also includes a respective front lateral beam or crossmember 3000 and a respective rear lateral beam or crossmember 3050 closing opposite ends 200E1, 200E2 of the space frame 200S. At least one of the longitudinal hollow section beams 3010, the front lateral beam 3000, and the rear lateral beam 3050, is/are selectable from a number of different selectably interchangeable respective longitudinal hollow section beams 3010A-3010n, front lateral beams 3000A-3000n, and rear lateral beams 3050A-3050n, each with different predetermined mechanical characteristics. Examples of the different predetermined mechanical characteristics include, but are not limited to, material, cross-section, etc. Here, selection of the at least one of the longitudinal hollow section beams 3010, the front lateral beam 3000, and the rear lateral beam 3050 from the number of different selectably interchangeable respective longitudinal hollow section beams 3010A-3010n, the front lateral beams 3000A-3000n, and the rear lateral beams 3050A-3050n determines the selected variable configuration of the chassis 200.

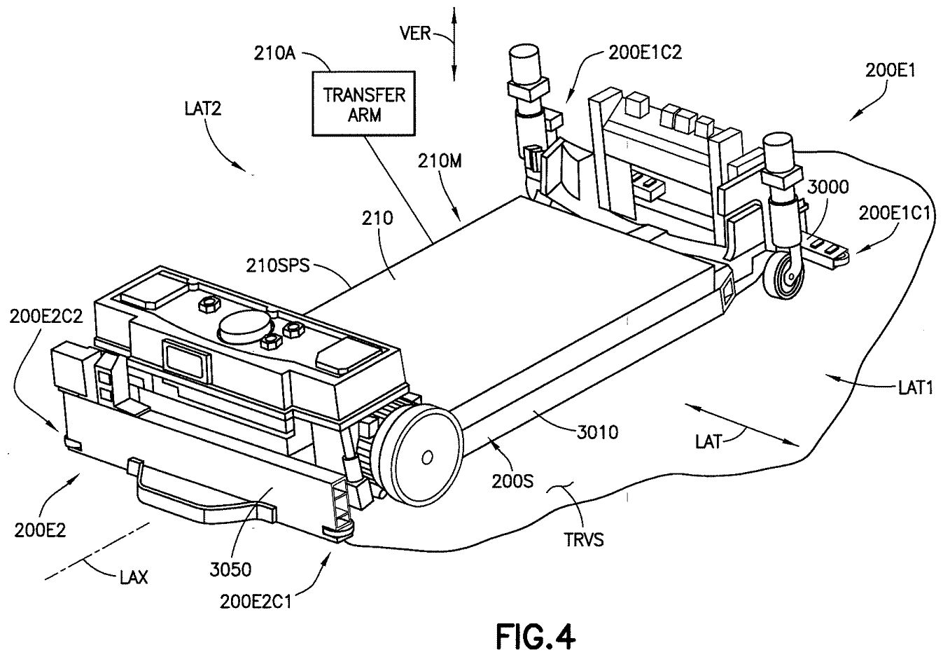

In one or more aspects the chassis includes the transfer arm 210A that extends/retracts laterally relative to the payload support 210B where the transfer arm 210A may be movable in the vertical direction VER (see FIGS. 4 and 5) in any suitable manner by any suitable distance so that the transfer arm 210A is above/clears the chassis 200 when the transfer arm 210A is extended/retracted. The transfer arm 210A may be provided as a part of the payload support module 210M as described herein. In some aspects, the payload support 210 is an active payload support 210ACT where the payload support 210 and transfer arm 210A are coupled to at least one payload support stanchion module 211, 212 (also referred to as a payload support stanchion or lift towers-see FIG. 5) as described herein, where in some aspects the payload support stanchions 211, 212 are configured to move one or more of the payload support 210 and transfer arm 210A in vertical direction VER so that the bot 110 transfers case units to and from two or more stacked storage shelves 688A, 688B (e.g., of the storage rack modules RMA, transfer stations TS, buffer stations BS, etc.) from a common bot riding surface CRS (see FIG. 6). In other aspects, the payload support 210 may be a static payload support 210SPS (FIG. 4) where the transfer arm 210A is configured for case unit transfer to a single (e.g., level) storage shelf 688C. In some aspect, the payload support stanchion modules 211, 212 may also be provided as a part of the payload support module 210M or as separate modules to which the payload support module 210M is coupled.

Referring to FIGS. 3, 4, and 5 the payload support 210 is a modular unit/assembly (e.g., the payload support module 210M) that includes at least the payload bed 210B. Where the payload support 210 comprises the static payload support 210SPS (FIG. 4) the payload support 210 is coupled substantially directly to the chassis 200 or statically coupled to the payload support stanchions 211S, 212S (e.g., the payload support stanchions 211S, 212S do not include vertical actuation of at least the payload support 210). Where the payload support 210 is an active payload support 210ACT (FIG. 5A), the payload support contact surface 210BS (of payload bed 210B) is coupled to the at least one payload support stanchion 211, 212. The at least one payload support stanchion includes a lift drive system 555 is configured to move the payload support contact surface 210BS and/or transfer arm 210A in direction VER where the movement of the payload support contact surface 210BS and/or transfer arm 210A is guided by the at least one payload support stanchion 211, 212 in any suitable manner; while in other aspects substantial vertical movement of the payload bed 210B and/or transfer arm 210A may not be provided in direction VER. The transfer arm 210A is movably coupled to the payload support 210 for bi-directional lateral movement in direction LAT as described herein.

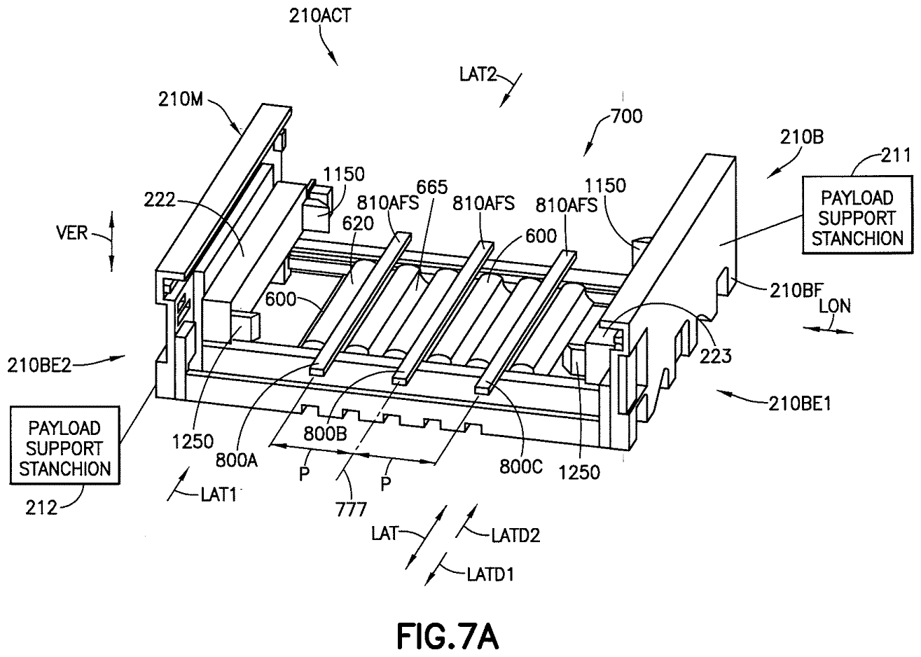

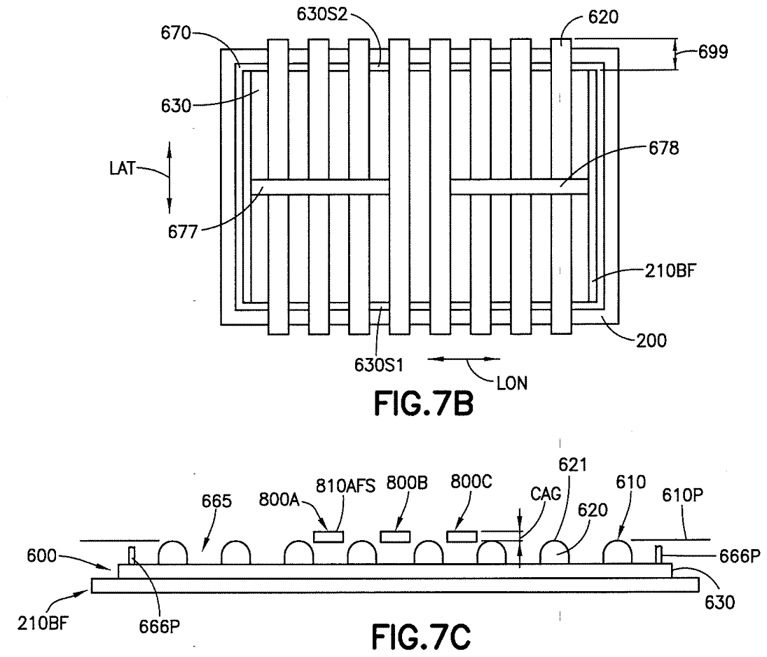

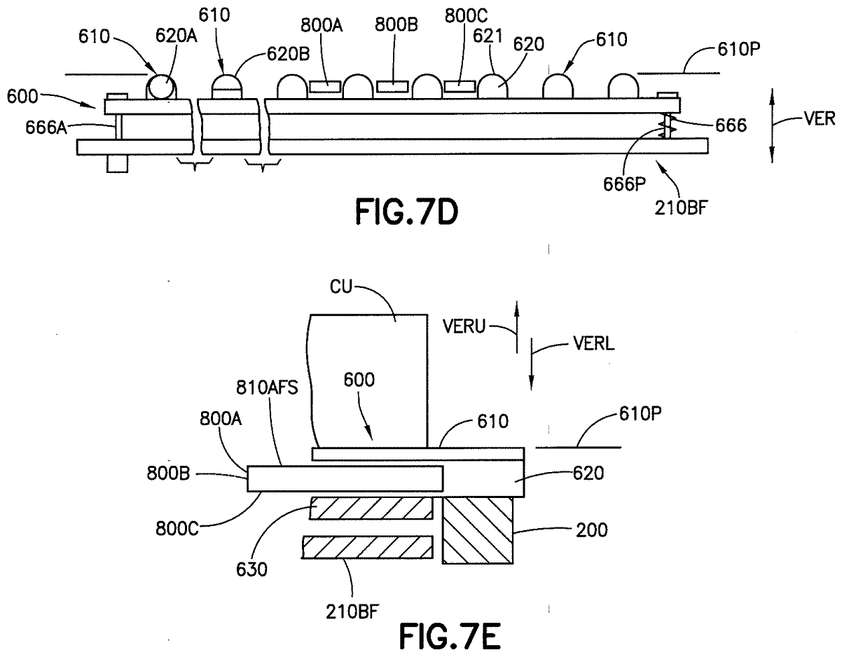

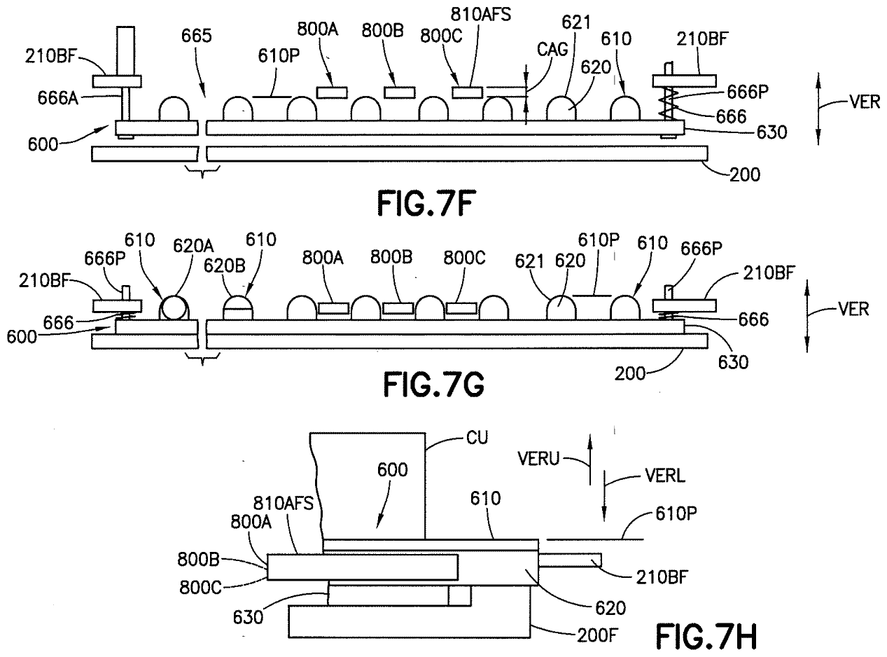

Referring also to FIG. 7A, the payload bed 210B includes a payload bed frame 210BF that forms a payload area 700 in which case units CU carried by the bot 110 are disposed for transport throughout the storage and retrieval system 100. The payload bed frame 210BF includes longitudinal ends 210BE1, 210BE2 that are each coupled to a respective one of the at least one payload support stanchion 211, 212 in any suitable (modular) manner. Here the at least one payload support stanchion 211, 212 includes payload support stanchion 211 disposed at or adjacent the front end 200E1 of the chassis 200 for coupling with the end 210BE1 of the payload bed frame 210BF and payload support stanchion 212 disposed at or adjacent the back end 200E2 of the chassis 200 for coupling with the end 210BE2 of the payload bed frame 210BF.

The payload support 210 is provided as a modular assembly (e.g., payload support module 210M) that is selected from a number of different interchangeable payload support modules 210MA-210Mn (it is noted that while FIG. 7A illustrates an active payload support 210ACT assembly it should be realized different modular static payload support 210SPS may also be provided-see FIG. 2), each payload support module having a different predetermined payload support module characteristic (e.g., active case transfer (payload bed with end effector/transfer arm), a passive case transfer (payload bed without actuated end effector/transfer arm as described herein), lift capability, length, width, different size payload actuators for different sized payload, etc.). The different payload support modules 210MA-210Mn have longitudinal lengths and lateral widths that correspond with the longitudinal length and a lateral width of the chassis (as effected through selection of the front lateral beams 3000A-3000n, the rear lateral beams 3050A-3050n, the longitudinal hollow section beams 3010A-3010n, and the payload support stanchions 212A-212n). In this manner one of the payload support modules 210M1-210Mn is selected depending on a predetermined chassis configuration for installation to the chassis in a modular manner (i.e., the selected payload support 210 is coupled to the at least one payload support stanchion 211, 212 without modification to either the payload support 210, the payload support stanchions 211, 212, and the chassis).

In one or more aspects, the payload support stanchions 211, 212 form a portion of a respective one of different interchangeable payload support modules 210MA-210Mn, where the payload support stanchions 211, 212 are pre-assembled to the longitudinal ends 210BE1, 210BE2 of the payload bed frame 210BF so that the payload support stanchions 211, 212 form a modular unit with the payload support 210; while in other aspects the payload support stanchions 211, 212 are selected from the different payload support stanchions 212A-212n based on at least a desired vertical travel distance and chassis width. Here, the modular combination of the payload support stanchions 211, 212 and the payload support 210 are selected from the different interchangeable payload support modules 210MA-210Mn and coupled to the chassis 200 as a payload support modular unit.

Still referring to FIGS. 3-5 and 7A and also to FIGS. 7B-7H, as described above, the payload bed frame 210BF is coupled to and extends between the lift towers 211, 212. In other aspects, the payload bed frame 210BF is cantilevered from one lift tower or coupled to more than two lift towers. The payload bed frame 210BF has mounted thereon a justification tray 600. The justification tray 600 includes a base 630 and at least one case unit support surface 610 coupled to the base 630 (or integrally formed with the base 630) in any suitable manner. The at least one case unit support surface 610 forms a case unit support plane 610P along which case units CU carried by the bot 110 can be moved laterally and/or longitudinally to justify/reposition the case units CU on the payload bed 210B as will be described herein. The at least one case unit support surface 610, in one or more aspects, is/are one or more protrusions 620 that extend from the base 630 where each protrusion 620 has an arcuate surface 621 upon which the case units are supported. In other aspects, the at least one case unit support surface 610 is/are one or more laterally extending rollers 620A that extend in direction LAT; while in still other aspects the at least one case unit support surface 610 is formed by a plurality of ball bearings 620B that form a ball transfer table; while in still other aspects the at least one case unit support surface 610 may be formed by a combination of protrusions, rollers, and ball bearings.

Referring to FIGS. 7B and 7F-7H, the base 630 of the justification tray 600 is coupled to the payload bed frame 210BF in any suitable manner so that as the payload bed frame 210BF moves in direction VER relative to the bot 110 frame 200F the justification tray 600 moves with the payload bed frame 210BF. For example, the payload bed frame 210BF includes guide members 666P (e.g., posts, rods, etc.) that hold the justification tray captive to the payload bed frame 210BF and along which the justification tray slides in direction VER. In one or more aspects, any suitable biasing member(s) 666 (e.g., springs, resilient/rubber bushings, etc.) are provided and bias (in direction VERL) the justification tray 600 away from the payload bed frame 210BF; while in other aspects gravity and/or biasing members 666 may bias the justification tray 600 in direction VERL. With the justification tray 600 biased away from the payload bed frame 210BF (see FIG. 7F), case unit support surfaces 810AFS of tines or fingers 800A-800C of the transfer arm 210A (as will be described herein) are disposed above the payload support plane 610P of the justification tray 600. With the justification tray 600 moved toward the payload bed frame 210BF (e.g., against the biasing force of the biasing member(s) 666 and/or against the force of gravity-such as by contact of the justification tray 600 with the frame 200F) the case unit support surfaces 810AFS of tines or fingers 800A-800C of the transfer arm 210A are disposed below the payload support plane 610P (see FIGS. 7G and 7H) so that case units CU are transferred from the case unit support surfaces 810AFS of the fingers 800A-800C to the support surface(s) 610 of the justification tray 600.

As illustrated in FIGS. 7B and 7G, at least a portion of the payload bed frame 210BF and at least a portion the base 630 of the justification tray 600 are shaped and sized to fit within and be recessed into the frame 200 of the bot 110. The justification tray 600 is configured so that the protrusions 620 (or in the case of the rollers 620A and ball bearings 620B any suitable tabs or portion of the base 630) extends over the frame 200F (in the aspect illustrated in FIG. 7B the protrusions extend laterally in direction LAT but in other aspects any suitable tabs may extend longitudinally in direction LON and/or laterally in direction LAT) so that as the portion of the payload bed frame 210BF is lowered/recessed (e.g., by the lift towers 211, 212) in direction VERL into an opening 670 of the frame 200 the protrusions 620 abut the frame 200 (or any other suitable hard stop surface of the bot 110) causing the justification tray 600 to be seated on the frame 200 (or any other suitable hard stop surface of the bot 110) and move toward the payload bed frame 210BF. As the payload bed frame 210BF continues to move in direction VERL (with the movement of the justification tray 600 in direction VERL stopped by the frame 200F) the payload support plane 610P is positioned above the case unit support surfaces 810AFS of tines or fingers 800A-800C to transfer case units CU from the fingers 800A-800C to the justification tray 600 (e.g., support of the case units are transferred from the transfer arm 210A to the justification tray 600 for justification/repositioning in directions LON, LAT). Any suitable resilient material (e.g., rubber (or other elastomeric/resilient material) bushings, pads, etc.) may be placed between the justification tray 600 and the frame 200 to substantially dampen vibrations from the frame 200 to the justification tray 600 and vice versa.

With the case units justified/repositioned, the lift towers 211, 212 move the payload bed 210B in direction VERU so that the biasing members 666 and/or gravity bias (e.g. in direction VERL) the justification tray 600 away from the payload bed frame 210BF. With continued movement of the payload bed 210B in direction VERU the case unit support surfaces 810AFS of the fingers 800A-800C move past (e.g., above) the payload support plane 610P of the justification tray 600 to transfer support of the case units CU from the justification tray 600 to the fingers 800A-800C. As may be realized, the case units CU can be transported by the bot 110 with the case units CU supported on the justification tray and/or supported on the fingers 800A-800C. The justification tray 600 is also configured to retain, such as in troughs 665 (see FIG. 7C) adjacent/between the case unit support surfaces 610, any debris (e.g., liquids and/or solids) from the case units CU held/supported in the payload bed 210B by the transfer arm 210A or justification tray 600. Retention of case unit debris by the justification tray 600 may prevent the debris from falling on, for example, the transfer deck 130B (FIG. 1) and picking aisles 130A (FIG. 1) where such fallen debris may decrease wheel traction between the bot 110 wheels and the travel/support surfaces of the transfer deck 130B and picking aisles 130A.

Referring to FIGS. 7B-7E, in one or more alternate aspects, the base 630 of the justification tray 600 is coupled to the payload bed frame 210BF in any suitable manner (such as with guide members 666P) so that as the payload bed frame 210BF moves in direction VERT relative to the bot 110 frame 200 the justification tray 600 moves with the payload bed frame 210BF. In one or more aspects, the justification tray 600 is coupled to the payload bed frame 210BF by a biased coupling that provides relative movement of the justification tray 600 relative to the payload bed frame 210BF in direction VERT while biasing the justification tray 600 against the payload bed frame 210BF in direction VERT. For example, any suitable biasing member(s) 666 (e.g., springs, resilient/rubber bushings, etc.) bias the justification tray 600 in direction VERL towards the payload bed frame 210BF (see FIG. 6A) and provide for the relative movement between the justification tray 600 and the payload bed frame in direction VERT. With the justification tray 600 biased against the payload bed frame 210BF (see FIG. 6B), case unit support surfaces 810AFS of tines or fingers 800A-800C of the transfer arm 210A (as will be described herein) are disposed above the payload support plane 610P of the justification tray 600. With the justification tray 600 moved away from the payload bed frame 210BF (e.g., against the biasing force of the biasing member(s) 666—such as by contact with the frame 200) the case unit support surfaces 810AFS of tines or fingers 800A-800C of the transfer arm 210A are disposed below the payload support plane 610P (see FIGS. 7D and 7E) so that case units CU are transferred from the case unit support surfaces 810AFS of the fingers 800A-800C to the support surface(s) 610 of the justification tray 600.

As illustrated in FIGS. 7B and 7E, at least a portion of the payload bed frame 210BF and at least a portion the base 630 of the justification tray 600 are shaped and sized to fit within and be recessed into the frame 200 of the bot 110. The justification tray 600 is configured so that the protrusions 620 (or in the case of the rollers 620A and ball bearings 620B any suitable tabs or portion of the base 630) extends over the frame 200 (in the aspect illustrated in FIG. 7B the protrusions extend laterally in direction LAT but in other aspects any suitable tabs may extend longitudinally in direction LON and/or laterally in direction LAT) so that as the portion of the payload bed frame 210BF is lowered/recessed (e.g., by the lift towers 211, 212) in direction VERL into an opening 670 of the frame 200 the protrusions 620 abut the frame 200 (or any other suitable hard stop surface of the bot 110) causing the justification tray 600 to be seated on the frame 200 (or any other suitable hard stop surface of the bot 110) and become spaced apart from the payload bed frame 210BF (e.g., the movement of the justification tray 600 in direction VERL is stopped by the frame 200F while the payload bed frame 210BF continues to move in direction VERL). As the payload bed frame 210BF continues to move in direction VERL the case unit support surfaces 810AFS of the fingers 800A-800C move past (e.g., beneath) the payload support plane 610P of the justification tray 600 to transfer case units CU from the fingers 800A-800C to the justification tray 600 (e.g., support of the case units are transferred from the transfer arm 210A to the justification tray 600 for justification/repositioning in directions LON, LAT).

With the case units justified/repositioned, the lift towers 211, 212 move the payload bed 210B in direction VERU so that the biasing members 666 bias (e.g. in direction VERL) the justification tray 600 against the payload bed frame 210BF. With continued movement of the payload bed 210B in direction VERU the case unit support surfaces 810AFS of the fingers 800A-800C move past (e.g., above) the payload support plane 610P of the justification tray 600 to transfer support of the case units CU from the justification tray 600 to the fingers 800A-800C. As may be realized, the case units CU can be transported by the bot 110 with the case units CU supported on the justification tray and/or supported on the fingers 800A-800C. The justification tray 600 is also configured to retain, such as in troughs 665 (see FIG. 7C) adjacent/between the case unit support surfaces 610, any debris (e.g., liquids and/or solids) from the case units CU held/supported in the payload bed 210B by the transfer arm 210A or justification tray 600. Retention of case unit debris by the justification tray 600 may prevent the debris from falling on, for example, the transfer deck 130B (FIG. 1) and picking aisles 130A (FIG. 1) where such fallen debris may decrease wheel traction between the bot 110 wheels and the travel/support surfaces of the transfer deck 130B and picking aisles 130A.

The justification tray 600 is positioned relative to the fingers 800A-800C of the transfer arm 210A so that, with the payload bed 210B raised relative to the frame 200 for picking and/or placing a case unit CU, the case unit support surface 810AFS of the fingers 800A-800C are located a distance (e.g., gap) CAG above the support surface 610 of the justification tray 600. This gap CAG is sized (i.e., minimized) only to allow sufficient clearance between a case unit CU supported on the fingers 800A-800C so that movement of the case unit CU above the support surface 610 (e.g., the arcuate support surfaces 621) is without contact between the case unit CU and the support surface 610. As will be described herein. The minimized gap CAG effects, with relative vertical movement between the fingers 800A-800C and justification tray 600 (e.g., where the relative movement of the justification tray 600 effected by the frame 200F or an actuator 666A), seating of the case unit CU on the justification tray 600 substantially immediately proximate to the end effector 210A positioning the underpick case unit CU within the payload bay 210B loading the payload bay 210B. For example, when a transfer arm 210A retract movement into the payload bed 210B is complete, the relative movement between the transfer arm 210A and the justification tray 600 substantially coincident with and substantially immediately upon completion of retract movement transfers the case unit CU to justification tray 600.

The support surface 610 has a sufficient coefficient of friction to stably hold the case unit CU thereon so as to register the case unit CU in two degrees of registration (vertically in direction VER and planar in directions LON, LAT-see FIG. 7A) to effect commencement of autonomous transport vehicle 110 traverse motion (without the case unit being gripped by the justification bars 222, 223 and/or the arm tabs 1150, 1250, as will be described herein) substantially coincident with completion of retract movement (e.g., the case unit is retracted into the payload bed 210B, securely registered on the justification tray 600, and the vehicle 110 traverse is commenced in about 10 seconds or less). As described herein, the justification tray 600 extends above the fingers 800A-800C through contact with the frame 200; however, the payload bay 210B may include linear actuators 666A (se FIGS. 7C and 7F) to raise or lower the justification tray 600 relative to the fingers 800A-800C. As an example, the actuators 666A may be employed where the transfer arm 210A and payload bed 210B are raised (e.g., via the lift towers 211, 212) to pick case units CU from an upper storage shelf 688B of an array of stacked shelves as described herein (see FIG. 6).

While description of the justification tray 600 is provided above with respect to FIGS. 7A-7H, such description is exemplary only and in other aspects the justification tray may be any suitable payload support surface configured for supporting a payload (such as case unit CU) in transport by the bot 110. Suitable examples of payload support surfaces can be found in, for exemplary purposes only, U.S. Pat. No. 10,822,168 issued on Nov. 3, 2020; U.S. Pat. No. 8,425,173 issued on Apr. 23, 2013); U.S. Pat. No. 9,561,905 issued on Feb. 7, 2017; U.S. Pat. No. 8,965,619 issued Feb. 24, 2015; U.S. Pat. No. 8,696,010 issued on Apr. 15, 2014; U.S. Pat. No. 9,187,244 issued Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; U.S. Pat. No. 9,850,079 issued on Dec. 26, 2017; and U.S. patent application Ser. No. 17/664,843, filed on May 24, 2022 having attorney docket number 1127P016040-US (PAR) and tiled “Autonomous Transport Vehicle, and which is a non-provisional of U.S. provisional patent application No. 63/241,893 filed on Sep. 8, 2021, the disclosures of which were previously incorporated by reference herein in their entireties.

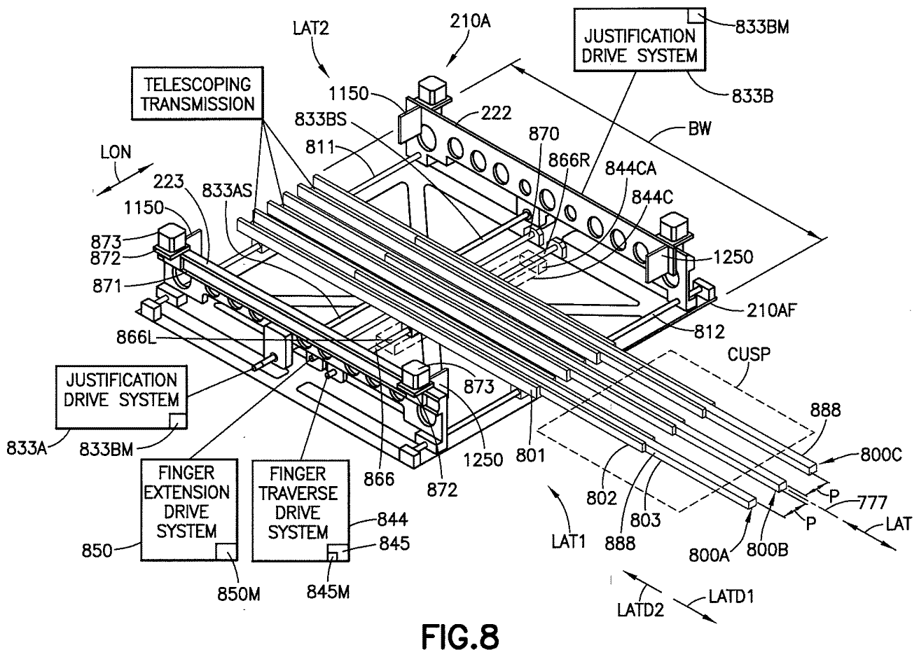

Referring to FIGS. 3-5, 7A and 8, the transfer arm 210A includes a frame 210AF to which the one or more fingers 800A-800C are coupled. With reference to FIG. 8, it is noted that, for exemplary purposes only, the transfer arm 210A is illustrated as having three fingers 800A-800C spaced apart from one another (with any suitable spacing) along the frame 210AF; however, the transfer arm 210A may have more or fewer than three fingers spaced apart from one another (with any suitable spacing) along the frame 210AF. The frame 210AF of the transfer arm 210A is coupled to the payload bed frame 210BF in any suitable manner so that the fingers 800A-800C are disposed relative to the justification tray 600 as described herein. While the frame 210AF of the transfer arm 210A is shown being separate and distinct from the payload bed frame 210BF, in other aspects, the payload bed 210BF and the transfer arm frame 210AF may be integral with each other, such that the transfer arm components described herein are mounted or otherwise coupled to the payload bed frame 210BF in a manner substantially similar to that described herein with respect to frame 210AF.

The transfer arm 210A includes at least one finger support member 812, 811. The finger support members 812, 811 are coupled to the frame 210AF in any suitable manner and form supporting guides that support the fingers 800A-800C and guide movement of at least one of the fingers 800A-800C in direction LON (e.g., along the longitudinal axis LAX of the bot 110—see FIG. 4). The finger support members 812, 811 are illustrated as rods for exemplary purposes only, while in other aspects the finger support members 812, 811 may be rails, or any other suitable structural member configured to at least guide movement of at least one of the fingers 800A-800C. In the example illustrated there are two finger support members 812, 811, each finger support member 812, 811 being disposed adjacent a respective lateral side LAT1, LAT2 of the frame 210AF so that the fingers 800A-800C define a case unit support plane CUSP as described herein; however, in other aspects, as will also be described herein, there may be one finger support member 812, 811 adjacent one of the lateral sides LAT1, LAT2 and a finger drive member (e.g., such as lead screw 866) disposed adjacent the other later side LAT1, LAT2 (or between the lateral sides LAT1, LAT2) so that the fingers define the case unit support plane CUSP. In still other aspects, the fingers 800A-800C are supported in any suitable manner so as to be moveable relative to the frame 210AF and form the case unit support plane CUSP.

Here, one or more of the fingers 800A-800C are movably coupled to the finger support member 812, 811 so as to be movable along the finger support member 812, 811 in the direction LON (along the longitudinal axis LAX-see FIG. 4) to at least change/vary a pitch or distance P (see also FIG. 7A) between the fingers 800A-800C. In one or more aspects, one or more of what may be referred to as outboard fingers 800A, 800C are movable relative to one or more of what may be referred to as inboard fingers 800B. For example, the finger 800B is stationarily fixed at a predetermined location on the at least one finger support member 812, 811 (e.g., finger 800B does not move relative to the finger support member 812, 811) such as at or along a laterally extending centerline 777 (see also FIG. 7A) of the payload bed 210B, or in other aspects the finger 800B may be driven in direction LON independently of one or more of the outboard fingers 800A, 800C.

At least the outboard fingers 800A, 800C are coupled to the at least one finger support member 812, 811 so as to move relative to each other and the finger 800B in direction LON; while in other aspects, each of the fingers 800A-800C are coupled to the at least one finger support member 812, 811 so as to move relative to each other. The transfer arm 210A includes a finger traverse drive system 844 having any suitable number of linear actuators 845 for effecting the movement of the fingers 800A, 800C or fingers 800A-800C in direction LON. The fingers 800A-800C may be movable in direction LON independent of each other, in a fixed relationship with one or more other fingers, or as a single unit. The linear actuator(s) 845 is/are any suitable actuator(s), examples of which include but are not limited to, pneumatic cylinders, hydraulic cylinders, ball-screw drives, lead-screw drives, rack and pinion drives, rotary arm-linkage drives, belt drives, chain drives, electric/magnetic actuators, or any other suitable drive configured to effect linear movement of the fingers along the finger support rail in direction LON.

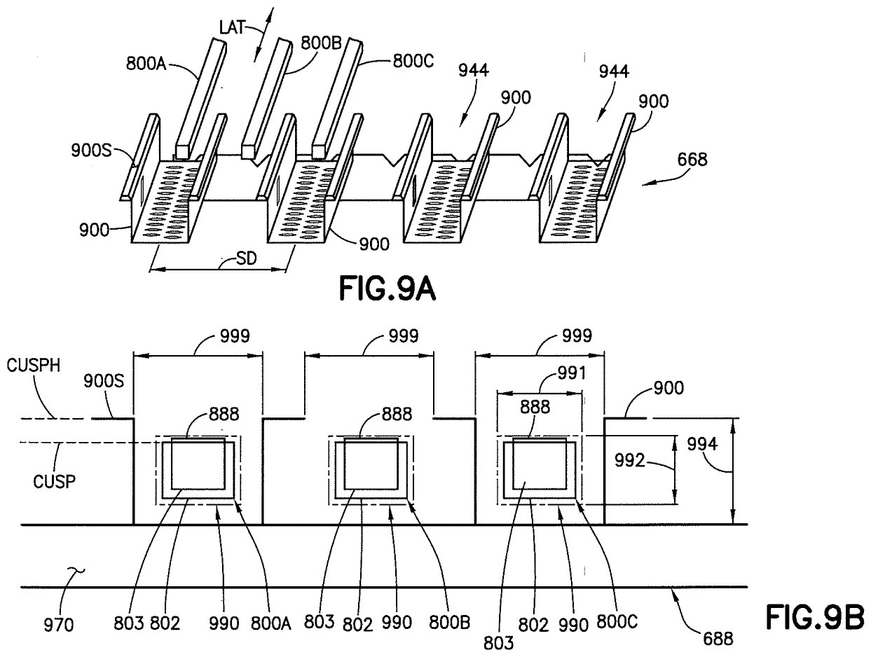

In one or more aspects, each finger 800A-800C has a respective linear actuator 845 so that the fingers 800A, 800C move independent of each other in direction LON, while in other aspects there is a single linear actuator 845 that is common to each finger 800A, 800C so that the single actuator 845 moves each of the fingers 800A, 800C in the direction LON in a fixed relationship. As an example, the linear actuator 845 is common to both fingers 800A, 800C and includes a stepper motor 845M (or other suitable motor) and a lead screw 866 having a right handed lead screw portion 866R, and a left handed lead screw portion 866L, where the lead screw 866 is coupled to the stepper motor 845M. One of the fingers 800A, 800C is coupled to the right handed lead screw portion 866R and the other of the fingers 800A, 800C is coupled to the left handed lead screw portion 866L so that as the stepper motor simultaneously rotates both the left and right handed lead screw portions 866L, 866R in a first rotation direction the fingers 800A, 800C move away from each other and away from the finger 800B to increase the distance P between the fingers 800A-800C. As the stepper motor 845M simultaneously rotates both the left and right handed lead screw portions 866L, 866R in a second rotation direction (opposite the first rotation direction) the fingers 800A, 800C move towards each other and towards the finger 800B to decrease the distance P between adjacent fingers 800A-800C. The distances P between adjacent fingers 800A-800C correspond with a size of a case unit to be picked/transferred (e.g., the cumulative distance between outboard fingers is sized to support, from underneath, side edges of a case unit held on the transfer arm 210A while the inboard finger(s) support, from underneath, a central portion of the case unit held by the transfer arm 210A), a spacing between protrusions 620 of the justification tray 600 (see FIG. 7A), and/or a spacing between slats SD (see FIG. 9A) of case unit supports 900 (FIG. 9A) at a case unit holding location.

As noted above, where a single actuator drives movement of the fingers 800A, 800C the distance P moved by each finger 800A, 800C relative to the finger 800B is substantially the same; however, the distance P moved by each finger 800A, 800C may be different relative to finger 800B where each finger 800A, 800C is driven by its own respective actuator. In some aspects, the finger 800B may also be driven along the at least one finger support member 812, 811 in direction LON.

As may be realized, the at least one finger support member 812, 811 is/are included with the finger traverse drive system 844, and along which the fingers 800A, 800C travel so that the fingers 800A, 800C are maintained in a predetermined orientation relative to the payload bed 210B, relative to each other, and relative to finger 800B so as to define, with the finger 800B, a case unit support plane CUSP (see FIGS. 8 and 9B). The case unit support plane CUSP being substantially parallel/coplanar with a case unit support plane CUSPH defined by the case unit supports 900 at a case unit holding location (FIG. 9B).

In one or more aspects, the actuator 845 and the finger 800B are coupled to a carriage 844C of the finger traverse drive system 844 so that the actuator 845 (and fingers 800A, 800C coupled thereto) and finger 800B move in direction LON along the at least one finger support member 812, 811 under impetus of actuator carriage actuator 844CA (e.g., actuator moves the fingers 800A-800C and the actuator 845 in direction LON). The carriage actuator 844CA may be substantially similar to actuator 845 described herein. Here, the fingers 800A-800C move as a unit in direction LON so as to be positioned underneath (so as to underpick) payloads CU and transport the payloads CU that have been justified in direction LON anywhere within the payload bed 210B (such as by justification bars 822, 823 as described herein). The carriage 844C is sized to provide for longitudinal movement of the fingers 800A-800C as described herein and so that the fingers can be positioned anywhere within the payload bed 210B in direction LON and arranged relative to each other so as to pick any suitable size payload CU. In one or more aspects, the carriage 844C may be a telescoping carriage having telescoping sections that extend and retract to provide the range of motion of the outboard fingers 800A, 800C described herein, while allowing the fingers 800A-800C to move together in direction LON as a single unit. The telescoping sections of the carriage 844C may be extended and retracted in any suitable manner so as to provide the range of motion (described herein) of the outboard fingers of the transfer arm 210A. Moving the fingers 800A-800C together as a unit (such as with carriage 844C) in direction LON or moving each finger 800A-800C independently in direction LON provides for a justified pick/placement of payloads CU (e.g., a center justification or off-center justification) in the manner described herein, where the payloads CU are justified by the justification bars 822, 823 (as described herein).

Still referring to FIGS. 7A and 8, as described herein, the fingers 800A-800C are telescoping fingers configured to bi-directionally extend in lateral directions LATD1, LATD2 outside of the bot payload area from either lateral side LAT1, LAT2 of the bot 110. The extension of the fingers 800A-800C in either direction LATD1, LATD2 outside of the bot payload area is a “deep reach” extension, where “deep reach” refers to extension of the fingers 800A-800C by a distance AR that effects pick/place of each case unit CU disposed on a shelf in a row of storage spaces (such as e.g., the storage spaces on shelf 688D in FIG. 6) where there are at least two storage spaces on the storage shelf inline with each other, and inline with the lateral picking direction LATD1, LATD2 (again, see FIG. 6 where, for exemplary purposes only, three case units are illustrated as being positioned on the storage shelf in three respective storage spaces, each accessible by the arm 210A, and disposed one behind the other in line with picking direction LATD2, three cases/storage spaces deep). For exemplary purposes each finger 800A-800C is configured (as described herein) to have an extended length (effecting the deep reach distance AR) that is substantially equal to about three bot widths BW (see FIG. 6); however, in other aspects each finger 800A-800C may have any suitable extended length for picking and placing case units in storage spaces that are arranged a lateral row (e.g., relative to the bot payload area) of at least two storage spaces (see FIG. 6). It is noted that in some aspects, deep reach may be effected with the case unit being picked/placed overhanging the tips of the transfer arm 210A fingers 800A-800C. Here, the transferred case unit is placed in the overhang condition, for placement of the case unit, by the tabs 1150, 1250 and is removed from the overhang condition, when retracted into the payload area, by the tabs 1150, 1250.

To effect the bi-directional deep reach extension of the fingers 800A-800C, each finger includes at least three telescoping finger stages. For example, each finger 800A-800C includes a base stage 801, a case unit support stage 803, and at least one intermediary stage 802 disposed between and coupling the base stage 801 and case unit support stage 803. As described herein, the base stage 801 is fixed (e.g., at least in the lateral direction) to the frame 210AF, the at least one intermediary stage 802 is slidably mounted to the base stage 801 for relative translation between to opposite lateral directions LATD1, LATD2, and the case unit support stage 803 is slidably mounted to the at least one intermediary stage 802 for relative translation along the same two opposite lateral directions LATD1, LATD2 (see FIG. 6). The coupling of the fingers 800A-800C to the frame 210AF and the coupling of the finger stages 801-803 to each other is such that with the fingers 800A-800C at maximum extension (e.g., as noted above) a maximum payload weight (e.g., such as payloads of up to about 60 lbs or more) is supported on the case unit support stage 803 (e.g., with minimal or substantially no deflection of the transfer arm 210A or fingers 800A-800C in direction VER). It is noted that the structure of the fingers 800A-800C is described herein with respect to finger 800A, but that the structure of fingers 800B, 800C is substantially similar to that of finger 800A unless otherwise noted.

The base stage 801 is coupled to the at least one finger support member 812, 811 and has a length substantially equal to the bot 110 width BW (see FIGS. 6 and 8). As described herein, the base stage 801 of fingers 800A, 800C is coupled to the finger traverse drive system 844 as described herein so that the fingers 800A, 800C move longitudinally. In some aspects, as also described herein, the base stage 801 of finger 800B may also be coupled to the finger traverse drive system 844. Here, the lateral position of the base section 801 of the fingers 800A-800C is fixed in the lateral direction relative to the frame 210AF. The base stage 801 has any suitable cross sectional shape that effects relative guided movement of the at least one intermediary section 802 relative to the base section 801. For example, the base stage 801 has a channel-shaped cross section in which the at least one intermediary section 802 is disposed for relative movement in directions LATD1, LATD2.

The at least one intermediary stage 802 is movably coupled (e.g., via any suitable slides/bearings) to the base stage 801. Each of the at least one intermediary stage 802 of a respective finger 800A-800C has a length substantially equal to the bot 110 width BW (see FIGS. 6 and 8). The at least one intermediary stage 802 moves relative to the base stage 801 so as to extend from either lateral side LAT1, LAT2 of the bot 110. The at least one intermediary stage 802 has any suitable cross sectional shape that effects relative guided movement of the case unit support stage 803 relative to the at least one intermediary stage 802. For example, the at least one intermediary stage 802 has a channel-shaped cross section in which the case unit support stage 803 is disposed for relative movement in directions LATD1, LATD2.

The case unit support stage 803 is movably coupled (e.g., via any suitable slides/bearings) to the at least one intermediary stage 802 and has a length substantially equal to the bot 110 width BW (see FIGS. 6 and 8). The case unit support stage 803 moves relative to the at least one intermediary stage 802 so as to extend from either lateral side LAT1, LAT2 of the bot 110. The case unit support stage 8032 has any suitable cross sectional shape that effects relative guided movement of the case unit support stage 803 relative to the at least one intermediary stage 802. For example, the case unit support stage 802 has a channel-shaped cross section, a T-shaped cross section, or any other suitable cross section. The case unit support stage 802 includes a protuberance 888 that extends above the at least one intermediary stage 802 and the base stage 801 so that the protuberances 888 of the fingers 800A-800C form the case unit support plane CUSP of the transfer arm 210A.

The transfer arm 210A also includes a finger extension drive system 850 configured to effect extension of the fingers 800A-800C in a first lateral direction LATD1 from lateral side LAT1 of the bot 110, and effect extension of the fingers 800A-800C in a second lateral direction (LATD2), i.e., opposite direction LATD1 from lateral side LAT2 of the bot 110. The finger extension drive system includes a motor 850M coupled to drive shaft 870. The drive shaft has mounted thereon pulleys, gears, or other drive transmission component that engages belts, chains, etc. of the fingers 800A-800C to effect bi-lateral extension and retraction of the fingers 800A-800C in directions LATD1, LATD2. In other aspects, any suitable linear actuators may be provided to bi-directionally extend and retract the fingers 800A-800C.

Still referring to FIG. 8 and also to FIGS. 9A and 9B, the movable extension stages each finger 800A-800C has a cross section that is sized and shaped to fit within a finger envelope 990 of the storage shelf 688 so that the transfer arm 210A underpicks (e.g., lifts from underneath) case units CU. For example, each storage shelf (storage shelf 688 is illustrated and described for exemplary purposes) includes a support rail 970 and case supports 900 coupled to the support rail 970 in any suitable manner (such as with removable fasteners, welding, etc.). The case supports include case seating surfaces 900S that are spaced apart from one another by a distance 999. The case seating surfaces 900S have a height 994 from the support rail and form the case unit support plane CUSPH of the storage shelf 688. For exemplary purposes only the distance 999 is about 2.5 inches and the height 994 is about 2 inches (although in other aspects the distance may be greater or less than about 2.5 inches and the height may be greater or less than about 2 inches).

Within each trough 944 formed between adjacent case seating surfaces 900S (e.g., by the distance 999 and height 994) is a respective finger envelope 990. The finger envelope 990 is a space envelope below the case unit support plane CUSPH in which a finger 800A-800C is inserted, between adjacent case seating surfaces 900S, with sufficient clearance around the finger 800A-800C to substantially avoid contact with the case supports 900 and any case units CU supported on the case seating surfaces 900S of the case supports 900. The finger envelope 990 has a height 992 and a width 991 that may be substantially centered within a respective trough (as illustrated in FIG. 9B). The height 992 is about 1.2 inches and the width 991 is about 1.7 inches (although in other aspects the height may be greater or less than about 1.2 inches and the width may be greater or less than about 1.7 inches—noting that the width and height of the finger envelope 990 must be smaller than the width and height of the respective trough).

Still referring to FIG. 8, the payload area includes justification bars 222, 223 and arm tabs 1150, 150 that justify and/or grip a case unit within the payload area. The justification bars 222, 223 are movably coupled to the transfer arm frame 210AF for movement in the direction LON in a manner substantially similar to that described herein with respect to fingers 800A-800C. For example, each justification bar is coupled to the at least one support member 811, 812 so as to move longitudinally (e.g., along the bot 110 longitudinal axis LAX-see FIG. 4)) in direction LON under impetus of a respective justification drive system 833A, 833B. In the example illustrated, justification bar 222 is moved in direction LON by the justification drive system 833B, which includes any suitable motor 833BM coupled to drive screw 833BS. Similarly, justification bar 223 is moved in direction LON by the justification drive system 833A, which includes any suitable motor 833BM coupled to drive screw 833AS. Here, the justification bars 222, 223 are movable, independent of each other, in direction LON so as to justify a case unit anywhere in the payload area in direction LON. In other aspects, the justification bars 222, 223 may be moved in an opposing manner such as in a manner described above with respect to fingers 800A, 800C and the left and right hand portions 866R, 866L of the screw 866 for center justification (e.g., longitudinally centered in the payload area) of a case unit CU held by the bot 110.

Each justification bar 222, 223 includes respective arm tabs 1150, 1250 that are movable towards and away from each other in directions LAT so as to grip and release case units, as well as justify case units in direction LAT within the payload area. The arm tabs 1150, 1250 will be described herein with respect to pusher bar 223, where the arm tabs of pusher bar 222 are substantially similar.

In one aspect, the pusher bar 222 includes a gear rack and rail 871 and each of the arm tabs 1150, 1250 includes a carriage 872 that rides along the rail (of the gear rack and rail 871) in direction LAT. A motor 873 including a pinion on its output is coupled to the carriage 872. The pinion engages the gear rack (of the gear rack and rail 871) so that as the motor 873 is actuated by, for example bot controller 1220, the respective arm tab 1150, 1250 moves along the gear rack and rail 871 in direction LAT. In other aspects, the carriage 872 may be moved along the rail (e.g., without a gear rack) by any suitable transmission such as belts/cables and pulleys, linear actuators, etc. The arm tabs 1150, 1250 are coupled to a respective carriage 872 so as to move as a unit with the carriage 872 and motor 873 in direction LAT along the gear rack and rail 871. As each of the arm tabs 1150, 1250 are independently driven, a case unit held in the payload area and gripped by the arm tabs 1150, 1250 can be justified in direction LAT anywhere within the payload area. In other aspects the arm tabs 1150, 1250 may be substantially similar to those described in U.S. patent application Ser. No. 17/664,948 filed on May 25, 2022 (having attorney docket number 1127P016039-US (PAR) and titled “Autonomous Transport Vehicle”) which is a non-provisional of U.S. provisional patent application No. 63/236,591 filed on Aug. 24, 2021, the disclosures of which were previously incorporated herein by reference in their entireties.

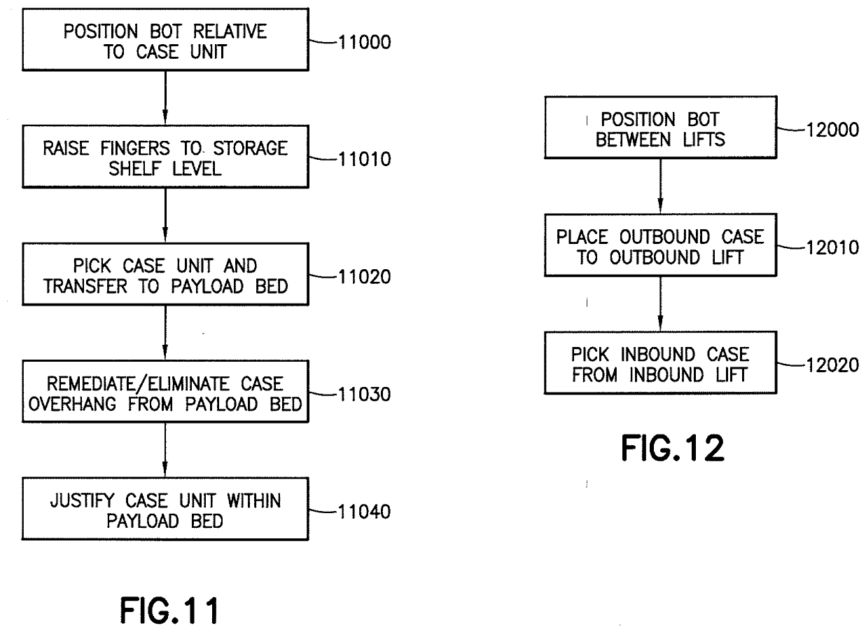

Referring to FIGS. 1, 2, 6, 8, and 10A-10E, an example of picking/placing operations with the bot 110 will be described. FIG. 6 illustrates a portion of the storage and retrieval system 100 showing the different storage levels 130L1-130Ln, where each storage level 130A-130Ln includes picking aisle rails 1600L1-1600Ln on which the bot 110 traverses along the picking aisle 130A. In the exemplary pick/place operation, a bot 110 on storage level 130L2 enters the picking aisle 130A and stops in the picking aisle 130A at the location of the case unit CU in any suitable manner (e.g., such as effected any suitable bot positioning sensors) (FIG. 11, Block 11000). The distance P between the fingers 800A, 800B, 800C is adjusted according to a size of the case unit CU in the manner described above. With the bot 110 on the pick aisle rails 1600L2 (e.g., the rails 1600L2 being common to both stacked storage shelves 688A, 688B) the fingers 800A-800C are moved in direction VERU to pick the case unit CU from the storage location 130S of one or more of the upper storage shelf 688B and the lower storage shelf 688A of level 130L2 respectively disposed at heights CUSH2, CUSH1 from the travel surface of the pick aisle rails 1600L2 (FIG. 11, Block 11010). Here, the fingers 800A-800C are moved in direction VERU to a predetermined one or more of pick heights PCKH1, PCKH2 by lifting the payload bed 210B (and the case unit support plane 610P thereof-see FIGS. 7C-7H) with the payload support stanchion modules 211, 212. The fingers 800A-800C are extended in at least one of directions LATD1, LATD2 so as to be positioned underneath the case unit(s) CU being picked. The fingers 800A-800C are lifted (e.g., such as with the payload support stanchion modules 211, 212) to pick the case unit from the storage shelf 688B. With the case unit CU supported on the fingers 800A-800C, the fingers 800A-800C are moved/retracted in other direction LATD1, LATD2 to transfer the case unit CU into the payload bed 210B (or moved/extended in direction LATD2 to transfer the case unit from the payload bed 210B) (FIG. 11, Block 11020).

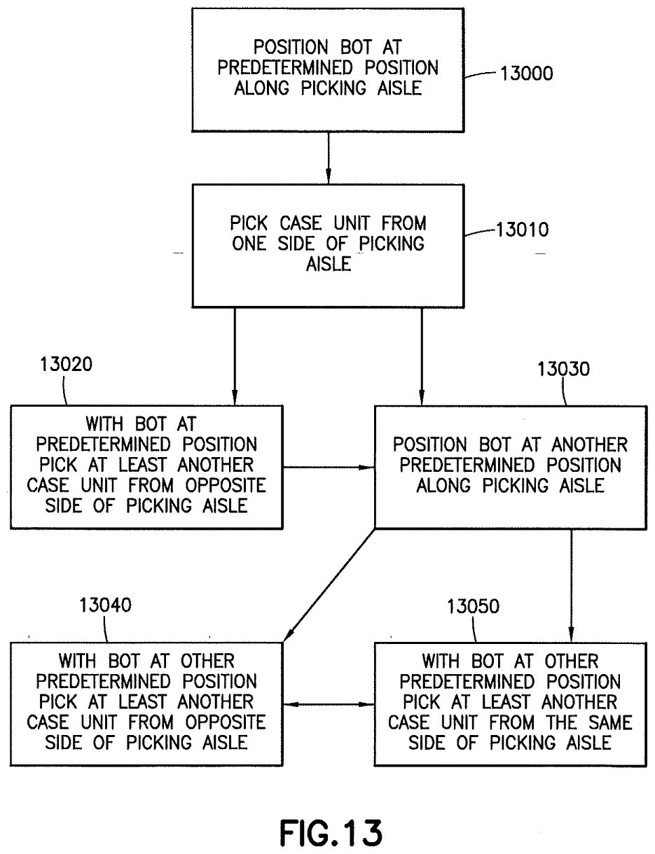

As may be realized, the bi-directional extension of the fingers 800A-800C described herein provide for extension of the fingers 800A-800C for picking and placing case units on either side of the picking aisle 130A (e.g., in any suitable combination of picks) without having the bot 110 leave the picking aisle 130A and to change a travel orientation of the bot 110 within the picking aisle (e.g., such as changing the travel orientation from the front end 200E1 of the bot 110 leading the direction of travel to having the rear end 200E2 of the bot 110 leading the direction of travel). For example, referring to FIGS. 2 and 6, each picking aisle 130A has two lateral sides 130AS1, 130AS2, along which sides are the storage spaces 130S. The bot 110 is positioned at a predetermined position along the picking aisle 130A (FIG. 13, Block 13000 for picking at least one case unit. With the bot 110 at the predetermined position within the picking aisle 130A, the fingers 800A-800C are extended to pick at least one case unit CU1 from one side 130AS2 of the picking aisle 130A (FIG. 13, Block 13010). With the bot remaining at the predetermined position, the fingers 800A-800C may be extended at least another case unit CU4 from the other opposite side 130AS1 of the picking aisle 130A (FIG. 13, Block 13020). The bot may be positioned at another predetermined position (different than the predetermined position) along the picking aisle 130A (FIG. 13, Block 13030) without the bot 110 exiting the picking aisle. With the bot 110 at the other predetermined position within the picking aisle 130A, the fingers 800A-800C are extended to pick at least one case unit CU2, CU3 from one of the side 130AS2 and the other opposite side 130AS1 of the picking aisle 130A (FIG. 13, Block 13040, 13050). With the bot remaining at the other predetermined position, the fingers 800A-800C are extended to pick another case unit CU2, CU3 from the other of the side 130AS2 and the other opposite side 130AS1 of the picking aisle 130A (FIG. 13, Block 13040, 13050). As may be realized, the picking of one or more of case units CU1-CU4 may be effected in any suitable order or combination, examples of which are provided above.

Still referring to FIGS. 1, 2, 6, 8, and 10A-10E, in the case unit transfer operations described herein, the payload or case unit CU is engaged by the payload support module 210M with at least two degrees of registration registering the payload substantially coincident with the arm 210A positioning the case unit CU on the payload contact support surface 610 loading the payload bay 210B. Again, referring also to FIGS. 7C-7H, the distance or gap CAG between the case unit support surface 810AFS of the fingers 800A-800C and the arcuate support surface 621 of the justification tray 600 is only so much (i.e., minimized) as to allow movement of the case unit CU above the arcuate support surfaces 621 without contact. Here, seating of the case unit CU on the justification tray 600 is substantially immediately proximate to the end effector 210A positioning the underpick case unit CU within the payload bay 210B loading the payload bay 210B as described above. In this example, the fingers 800A-800C and justification tray 600 are moved relative to each other (as described herein) to move the arcuate support surfaces 621 so the arcuate support surfaces 621 protrude above the case unit support surface 210AFS of the fingers 210AF. Here, seating of the case unit or payload CU on the arcuate support surfaces 621 of the support surface 610 (i.e., of the justification tray 600) registers the payload CU in the two degrees of registration (e.g., vertically in direction VER and planar in directions LON/LAT) substantially coincident with and substantially immediately upon a completed retraction of the fingers 800A-800C into the payload bed 210B. As described above, the arcuate support surfaces 621 are configured to stably hold the payload and allow the vehicle 110 to begin traverse movement (e.g., along the picking aisle 130A or transfer deck 130B) substantially coincident with seating of the payload on the justification tray 600.

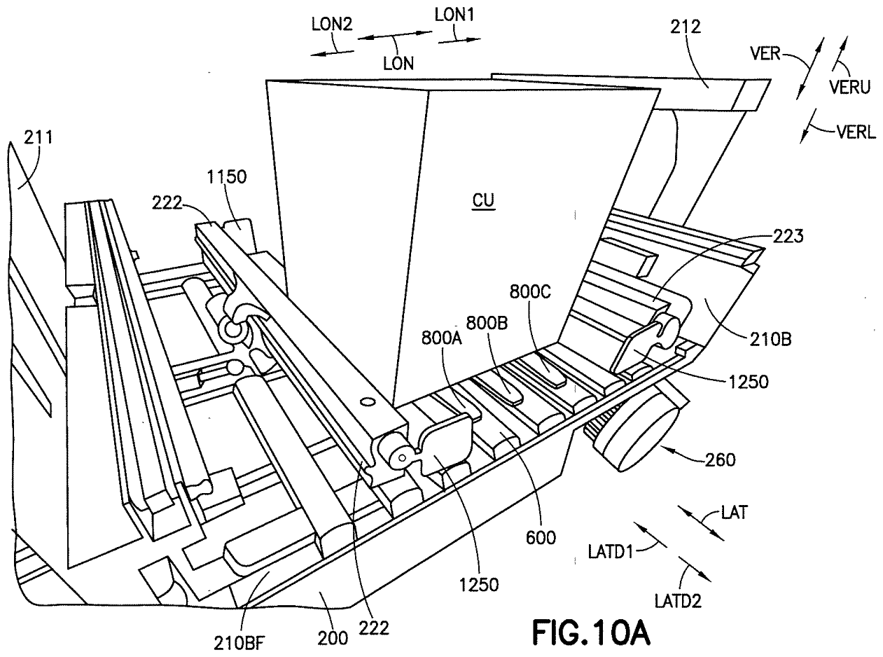

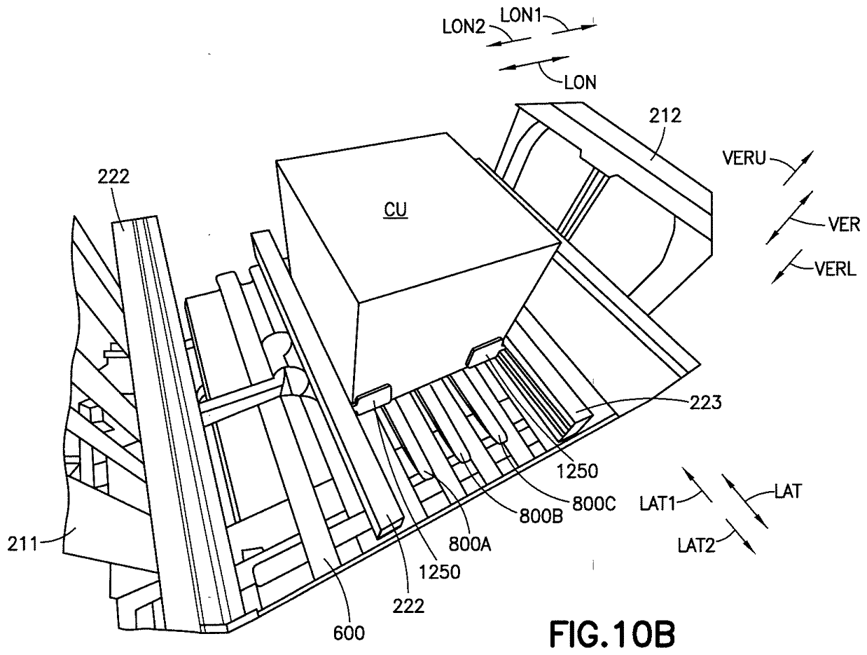

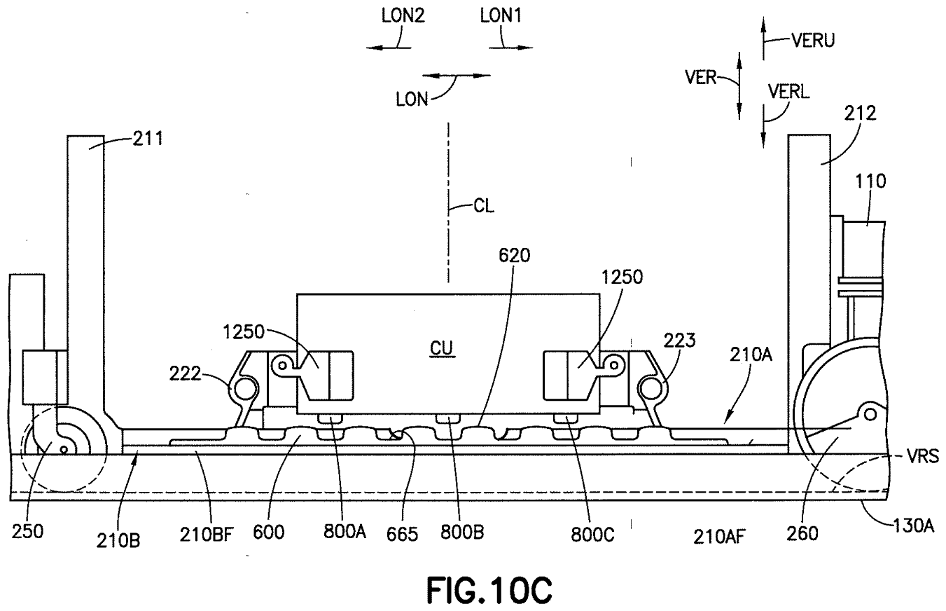

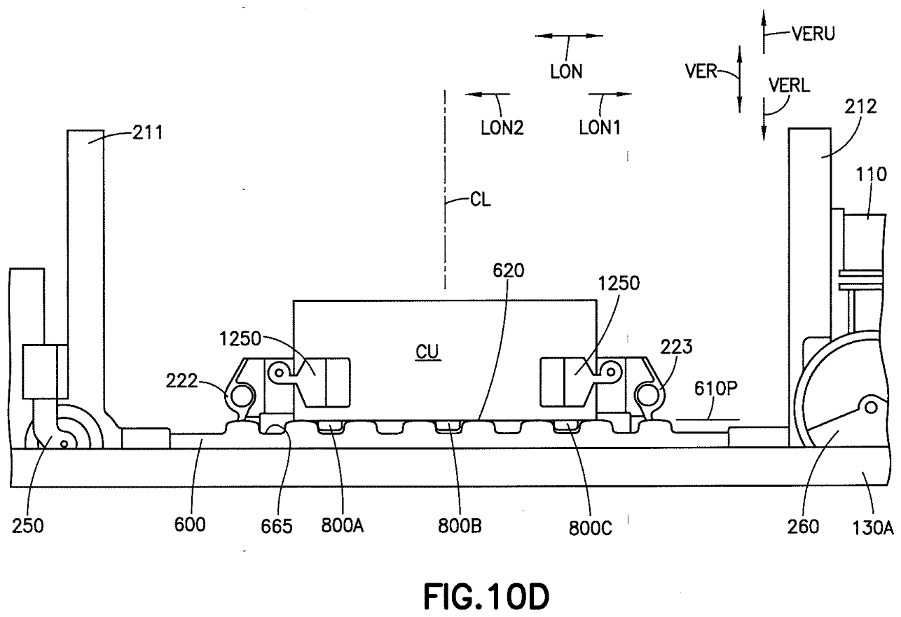

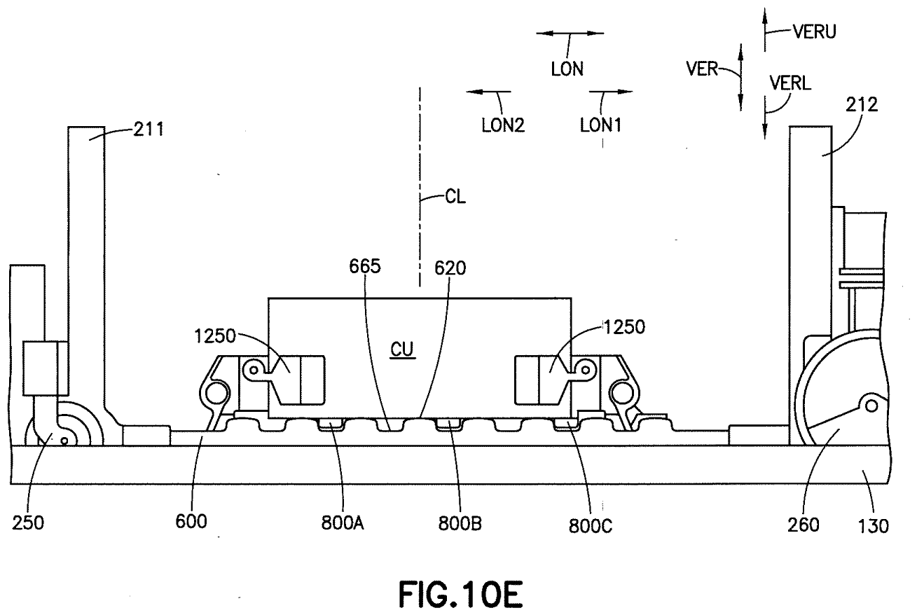

In a manner similar to that described above, substantially coincident with placement of the case unit CU on the support surface 610 the justification bars 222, 223 are moved in direction LON so that the justification bars 222, 223 are located adjacent to respective sides of the case unit CU. The justification bars 222, 223 may be moved in direction LON prior to or after the case unit being transferred to the payload bed 210B. Where the justification bars 222, 223 are moved in direction LON to be adjacent the respective sides of the case unit CU before the case unit CU is transferred into the payload bed 210B, the justification bars 222, 223 are moved based upon an expected size of the case unit to be picked. The arm tabs 1250 are moved in direction LAT1 so that the case unit CU is pulled into the payload bed 210B, as shown in FIG. 10B, to substantially remediate/eliminate any case overhang condition (e.g., the case unit CU extends at least partially out of the payload bed 210B past the payload bed frame 210BF and/or cantilevered tips of the fingers 800A-800C) (FIG. 11, Block 11030). In one or more aspects, substantially coincident with placement of the case unit CU on the support surface 610, the arm tabs 1150 are moved in direction LATD2 to push the case unit against the tabs 1250 for gripping the case unit.

In one or more aspects, the justification bars 222, 223 (e.g., of the bot 110 located on any of the levels 130L1-130Ln illustrated in FIG. 6 and transferring a case unit) are moved in direction LON to grip and or justify the case unit CU within the payload bed 210B. FIGS. 10B, 10C, and 10D illustrate a center justification of the case unit where the case unit is positioned by the justification bars 222, 223 substantially at or along a centerline CL of the payload bed. However, in other aspects, the case unit is justified to a location that is off-center relative to the centerline CL. As described above, the case unit CU is moved in direction LON, with the case unit CU held in the payload bed 210B, with the case unit CU being supported by the fingers 800A-800C and/or by the justification tray 600. FIG. 10D illustrates placement of the case unit CU onto the protrusions 620 of justification tray 600 for justification to a position off-center relative to centerline CL (see FIG. 10E) where the off-center position still allows the case unit CU to be lifted with all of the fingers 800A-800C substantially underneath the case unit CU. Placing a case unit from the justified location within the payload bed occurs in a manner substantially opposite to that described above.

In accordance with the aspects of the disclosed embodiment, and as described herein, the at least two degrees of registration include registration on the support surface 610, registration in direction LON and in direction LAT. For example, the arm 210A seating the case unit CU on the payload support plane 610P (e.g., on the justification tray 600) effects registration of the case unit CU in the at least two degrees of registration relative to the bot chassis 200 (See FIG. 10A). As described herein, the arm 210A seating of the case unit CU on the payload support plane 610P is substantially immediately proximate to the end effector positioning the underpick case unit CU within the payload bay 210B loading the payload bay 210B. It is noted that effecting at least two degrees of registration of the case unit CU substantially coincident with loading the payload bay 210B with the case unit CU enables initiation of vehicle 110 travel (transporting the loaded case unit CU along a picking aisle 130A or transfer deck 130B) substantially coincident with loading the case unit on the vehicle 110 for each case unit CU loaded on the vehicle 110, regardless of the case unit support plane CUSPH height CUSH1, CUSH2 relative to the bot chassis 200 or rails 1600L1-1600Ln (i.e., regardless of whether the case unit CU is picked from an upper storage shelf 688B or a lower storage shelf 688A of a level 130L1-130Ln) (FIG. 11, Block 11040).

Also, in the manner described above, and with the bot 110 on the common rails 1600L2 the fingers 210AF are moved in direction VERU to pick the case unit CU from the storage location 130S of one or more of the upper case unit supports 900U and the lower case unit supports 900L of level 130L2 respectively disposed at heights CUSH2, CUSH1. Here, the fingers 210AF are moved in direction VERU to a predetermined one or more of pick heights PCKH1, PCKH2 by lifting the payload bed 210B (and the case unit support plane 610P thereof) with the lift towers 211, 212. With the case unit CU supported on the fingers 210AF, the fingers 210AF are moved/retracted in direction LAT1 to transfer the case unit into the payload bed 210B (or moved/extended in direction LAT2 to transfer the case unit from the payload bed 210B) as illustrated in FIGS. 10A and 6.

Placement of a case unit CU onto a support shelf (e.g., in a storage space 130S or other suitable location of the storage and retrieval system) from the autonomous transport vehicle 110 may occur in a manner substantially opposite to that described above.

Referring again to FIGS. 2, 7A, and 8, as noted above, lifts 150A, 150B may be disposed on opposite sides of a pier 130PR (see, e.g., piers 130PR1, 130PR3 in FIG. 2). As can also be seen in FIG. 2, piers 130PR may be disposed on opposite sides of a common pier (i.e., two piers 130PR2, 130PR3 may service opposite sides of the same lift 150A-see FIG. 2). Referring to pier 130PR1, a bot 110 carrying a case unit CU enters the pier 130PR1 from the transfer deck 130B and is positioned between the lifts 150A, 150B (FIG. 12, Block 12000). The bot 110 extends arm 210A laterally in one direction (such as direction LATD1—see FIGS. 7A and 8) to place the (outbound) case unit CU on the outbound lift 150B (FIG. 12, Block 12010). Without leaving the pier 130PR1, the bot 110 extends arm 210A in the opposite direction (such as direction LATD2—see FIGS. 7A and 8) to pick another different (inbound) case unit CU from the inbound lift 150A (FIG. 12, Block 12020) for transfer to and placement in a storage location/space 130S.

Referring to piers 130PR2, 130PR3, bots carrying (outbound) case units CU enter a respective pier. The outbound lift 150B disposed between piers 130PR2, 130PR3 is accessible from both piers 130PR2, 130PR3 so that both bots 110 place the outbound case units on the lift 150B (e.g., to the same lift shelf, different lift shelves, simultaneously or in a predetermined placement order). The bot 110 may exit pier 130PR2 for picking another case unit from any suitable location of the storage and retrieval system 100. The other bot 110 may remain in pier 130PR3 for picking an inbound case unit CU from the inbound lift 150A in a manner substantially similar to that described above with respect to FIG. 12 and pier 130PR1 (e.g., where the bot bi-directionally extends the arm 210A in one direction to place the outbound case unit to outbound conveyor 150B and then extends the arm in the opposite direction to pick an inbound case from the inbound conveyor 150A).

In accordance with one or more aspects of the present disclosure, an autonomous transport vehicle for a storage and retrieval system is provided. The autonomous transport vehicle comprises:
a longitudinally elongated frame having a payload area, the payload area having opposing lateral sides;
wheels supporting the longitudinally elongated frame so as to configure the frame for traverse along traverse surfaces of a transfer deck and picking aisles of a storage and retrieval system, where the transfer deck provides vehicle traverse access to each of the picking aisles; and
a transfer arm coupled to the frame and disposed, at least in part, within the payload area, the transfer arm including telescoping fingers configured to support a payload and bi-directionally extend, from the payload area, from one of both of the opposing lateral sides to effect picking and placing of the payload at a payload holding location, of the picking aisle, adjacent the one of both of the opposing lateral sides.

In accordance with one or more aspects of the present disclosure, each telescoping finger includes at least three finger stages, each of the at least three finger stages having a length substantially equal to a width of the longitudinally elongated frame from one of the opposing lateral sides to another of the opposing lateral sides.

In accordance with one or more aspects of the present disclosure, the transfer arm comprises justification bars and a justification drive system, the justification drive system being configured to longitudinally move the justification bars to effect justification of the payload within the payload area.

In accordance with one or more aspects of the present disclosure, the transfer arm comprises tabs, each tab having a drive system configured to laterally move the tabs in the payload area to effect justification of the payload within the payload area.

In accordance with one or more aspects of the present disclosure, the transfer arms comprises a finger traverse drive system configured to adjust a distance between the telescoping fingers in a longitudinal direction of the longitudinally extended frame.

In accordance with one or more aspects of the present disclosure, the autonomous transport vehicle further comprises at least one lift, the transfer arm being coupled to the lift to effect transfer of payloads between the autonomous transport vehicle and stacked payload holding locations of the picking aisle.

In accordance with one or more aspects of the present disclosure, a material handling system comprises:
a storage structure having: picking aisles, storage spaces arranged along opposite sides of the picking aisles, a transfer deck coupled to each of the picking aisles; and
an autonomous transport vehicle having: a longitudinally elongated frame having a payload area, the payload area having opposing lateral sides, wheels supporting the longitudinally elongated frame so as to configure the frame for traverse along traverse surfaces of the transfer deck and the picking aisles, where the transfer deck is configured to effect autonomous transport vehicle traverse access to a respective traverse surface of each of the picking aisles, and a transfer arm coupled to the frame and disposed, at least in part, within the payload area, the transfer arm including telescoping fingers configured to support at least one payload and bi-directionally extend, from the payload area, from one of both of the opposing lateral sides to effect, with the autonomous transport vehicle in a picking aisle, transfer of the at least one payload between the payload area and at least one storage space of the storage spaces arranged along the opposite sides of the picking aisle with a single traverse of the autonomous transport vehicle through the picking aisle.

In accordance with one or more aspects of the present disclosure, each telescoping finger includes at least three finger stages, each of the at least three finger stages having a length substantially equal to a width of the longitudinally elongated frame from one of the opposing lateral sides to another of the opposing lateral sides.

In accordance with one or more aspects of the present disclosure, the transfer arm comprises justification bars and a justification drive system, the justification drive system being configured to longitudinally move the justification bars to effect justification of the payload within the payload area.

In accordance with one or more aspects of the present disclosure, the transfer arm comprises tabs, each tab having a drive system configured to laterally move the tabs in the payload area to effect justification of the payload within the payload area.

In accordance with one or more aspects of the present disclosure, the transfer arms comprises a finger traverse drive system configured to adjust a distance between the telescoping fingers in a longitudinal direction of the longitudinally extended frame.

In accordance with one or more aspects of the present disclosure, the material handling system further comprises at least one lift, the transfer arm being coupled to the lift to effect transfer of payloads between the autonomous transport vehicle and stacked payload holding locations of the picking aisle.

In accordance with one or more aspects of the present disclosure, a method of transferring payloads in a material handling system is provided. The method comprises:
providing a storage structure with picking aisles, payload holding spaces arranged along opposite sides of the picking aisles, and a transfer deck coupled to each of the picking aisles; and
transferring payloads between an autonomous transport vehicle and the payload holding spaces where the autonomous transport vehicle includes: a longitudinally elongated frame having a payload area, the payload area having opposing lateral sides, wheels supporting the longitudinally elongated frame so as to configure the frame for traverse along traverse surfaces of the transfer deck and the picking aisles, where the transfer deck is configured to effect autonomous transport vehicle traverse access to a respective traverse surface of each of the picking aisles, and a transfer arm coupled to the frame and disposed, at least in part, within the payload area, the transfer arm including telescoping fingers configured to support at least one payload;
wherein transferring the payloads is effected by bi-directionally extending the telescoping fingers, from the payload area, from one of both of the opposing lateral sides, with the autonomous transport vehicle in a picking aisle, to transfer the at least one payload between the payload area and at least one payload holding space of the payload holding spaces arranged along the opposite sides of the picking aisle with a single traverse of the autonomous transport vehicle through the picking aisle.

In accordance with one or more aspects of the present disclosure, the transferring the payloads includes placing a payload to a payload holding space on one side of the picking aisle and picking another payload from another payload holding space on an opposite side of the picking aisle.

In accordance with one or more aspects of the present disclosure, the payload and the another payload are transferred with the autonomous transport vehicle at a common location along the picking aisle.

In accordance with one or more aspects of the present disclosure, the payload and the another payload are transferred with the autonomous transport vehicle at different respective locations along the picking aisle.

In accordance with one or more aspects of the present disclosure, the transferring the payloads includes placing a payload to a payload holding space on one side of the picking aisle and picking another payload from another payload holding space on a same side of the picking aisle.

In accordance with one or more aspects of the present disclosure, the payload and the another payload are transferred with the autonomous transport vehicle at a common location along the picking aisle, where the payload and the another payload are transferred between the autonomous transport vehicle and respective payload holding spaces, the respective payload holding spaces being disposed at different elevations relative to the respective traverse surface of the picking aisle.

In accordance with one or more aspects of the present disclosure, the method further comprises providing the storage structure with lift modules adjacent the transfer deck, where the lift modules being disposed adjacent one another and transferring payloads between an autonomous transport vehicle and the payload holding spaces further includes: positioning the autonomous transport vehicle between the lift modules; and bi-directionally extending the telescoping fingers, from the payload area, from one of both of the opposing lateral sides to transfer the at least one payload between the payload area and at least one payload holding space of the lift modules arranged along the opposing lateral sides of the longitudinally elongated frame with a single traverse of the autonomous transport vehicle between the lift modules.

In accordance with one or more aspects of the present disclosure, the transferring the payloads includes placing payload to a payload holding space of one of the lift modules on one lateral side of the longitudinally elongated frame and picking another payload from another payload holding space of another of the lift modules on another lateral side of the longitudinally elongated frame.

It should be understood that the foregoing description is only illustrative of the aspects of the present disclosure. Various alternatives and modifications can be devised by those skilled in the art without departing from the aspects of the present disclosure. Accordingly, the aspects of the present disclosure are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the present disclosure.

What is claimed is:

1. An autonomous transport vehicle for a storage and retrieval system, the autonomous transport vehicle comprising:
a longitudinally elongated frame having a payload area, the payload area having opposing lateral sides;
wheels supporting the longitudinally elongated frame so as to configure the frame for traverse along traverse surfaces of a transfer deck and picking aisles of a storage and retrieval system, where the transfer deck provides vehicle traverse access to each of the picking aisles; and
a transfer arm coupled to the frame and disposed, at least in part, within the payload area, the transfer arm including telescoping fingers configured to support a payload and bi-directionally extend, from the payload area, from one of both of the opposing lateral sides to effect picking and placing of the payload at a payload holding location, of the picking aisle, adjacent the one of both of the opposing lateral sides.

2. The autonomous transport vehicle of claim 1, wherein each telescoping finger includes at least three finger stages, each of the at least three finger stages having a length substantially equal to a width of the longitudinally elongated frame from one of the opposing lateral sides to another of the opposing lateral sides.

3. The autonomous transport vehicle of claim 1, wherein the transfer arm comprises justification bars and a justification drive system, the justification drive system being configured to longitudinally move the justification bars to effect justification of the payload within the payload area.

4. The autonomous transport vehicle of claim 1, wherein the transfer arm comprises tabs, each tab having a drive system configured to laterally move the tabs in the payload area to effect justification of the payload within the payload area.

5. The autonomous transport vehicle of claim 1, wherein the transfer arms comprises a finger traverse drive system configured to adjust a distance between the telescoping fingers in a longitudinal direction of the longitudinally extended frame.

6. The autonomous transport vehicle of claim 1, further comprising at least one lift, the transfer arm being coupled to the lift to effect transfer of payloads between the autonomous transport vehicle and stacked payload holding locations of the picking aisle.

7. A material handling system comprising:
a storage structure having:
picking aisles,
storage spaces arranged along opposite sides of the picking aisles,
a transfer deck coupled to each of the picking aisles; and
an autonomous transport vehicle having:
a longitudinally elongated frame having a payload area, the payload area having opposing lateral sides,
wheels supporting the longitudinally elongated frame so as to configure the frame for traverse along traverse surfaces of the transfer deck and the picking aisles, where the transfer deck is configured to effect autonomous transport vehicle traverse access to a respective traverse surface of each of the picking aisles, and
a transfer arm coupled to the frame and disposed, at least in part, within the payload area, the transfer arm including telescoping fingers configured to support at least one payload and bi-directionally extend, from the payload area, from one of both of the opposing lateral sides to effect, with the autonomous transport vehicle in a picking aisle, transfer of the at least one payload between the payload area and at least one storage space of the storage spaces arranged along the opposite sides of the picking aisle with a single traverse of the autonomous transport vehicle through the picking aisle.

8. The material handling system of claim 7, wherein each telescoping finger includes at least three finger stages, each of the at least three finger stages having a length substantially equal to a width of the longitudinally elongated frame from one of the opposing lateral sides to another of the opposing lateral sides.

9. The material handling system of claim 7, wherein the transfer arm comprises justification bars and a justification drive system, the justification drive system being configured to longitudinally move the justification bars to effect justification of the payload within the payload area.

10. The material handling system of claim 7, wherein the transfer arm comprises tabs, each tab having a drive system configured to laterally move the tabs in the payload area to effect justification of the payload within the payload area.

11. The material handling system of claim 7, wherein the transfer arms comprises a finger traverse drive system configured to adjust a distance between the telescoping fingers in a longitudinal direction of the longitudinally extended frame.

12. The material handling system of claim 7, further comprising at least one lift, the transfer arm being coupled to the lift to effect transfer of payloads between the autonomous transport vehicle and stacked payload holding locations of the picking aisle.

13. A method of transferring payloads in a material handling system, the method comprising:
providing a storage structure with picking aisles, payload holding spaces arranged along opposite sides of the picking aisles, and a transfer deck coupled to each of the picking aisles; and
transferring payloads between an autonomous transport vehicle and the payload holding spaces where the autonomous transport vehicle includes:
a longitudinally elongated frame having a payload area, the payload area having opposing lateral sides,
wheels supporting the longitudinally elongated frame so as to configure the frame for traverse along traverse surfaces of the transfer deck and the picking aisles, where the transfer deck is configured to effect autonomous transport vehicle traverse access to a respective traverse surface of each of the picking aisles, and
a transfer arm coupled to the frame and disposed, at least in part, within the payload area, the transfer arm including telescoping fingers configured to support at least one payload;
wherein transferring the payloads is effected by bi-directionally extending the telescoping fingers, from the payload area, from one of both of f the opposing lateral sides, with the autonomous transport vehicle in a picking aisle, to transfer the at least one payload between the payload area and at least one payload holding space of the payload holding spaces arranged along the opposite sides of the picking aisle with a single traverse of the autonomous transport vehicle through the picking aisle.

14. The method of claim 13, wherein the transferring the payloads includes placing a payload to a payload holding space on one side of the picking aisle and picking another payload from another payload holding space on an opposite side of the picking aisle.

15. The method of claim 14, wherein the payload and the another payload are transferred with the autonomous transport vehicle at a common location along the picking aisle.

16. The method of claim 14, wherein the payload and the another payload are transferred with the autonomous transport vehicle at different respective locations along the picking aisle.

17. The method of claim 13, wherein the transferring the payloads includes placing a payload to a payload holding space on one side of the picking aisle and picking another payload from another payload holding space on a same side of the picking aisle.

18. The method of claim 17, wherein the payload and the another payload are transferred with the autonomous transport vehicle at a common location along the picking aisle, where the payload and the another payload are transferred between the autonomous transport vehicle and respective payload holding spaces, the respective payload holding spaces being disposed at different elevations relative to the respective traverse surface of the picking aisle.

19. The method of claim 13, further comprising providing the storage structure with lift modules adjacent the transfer deck, where the lift modules being disposed adjacent one another and transferring payloads between an autonomous transport vehicle and the payload holding spaces further includes:
positioning the autonomous transport vehicle between the lift modules; and
bi-directionally extending the telescoping fingers, from the payload area, from one of both of the opposing lateral sides to transfer the at least one payload between the payload area and at least one payload holding space of the lift modules arranged along the opposing lateral sides of the longitudinally elongated frame with a single traverse of the autonomous transport vehicle between the lift modules.

20. The method of claim 19, wherein the transferring the payloads includes placing a payload to a payload holding space of one of the lift modules on one lateral side of the longitudinally elongated frame and picking another payload from another payload holding space of another of the lift modules on another lateral side of the longitudinally elongated frame.
